(19) United States
(12) Patent Application Publication
(10) Pub. No.: US 2022/0349150 A1
(43) Pub. Date: Nov. 3, 2022

(54) WORK MACHINE AND INFORMATION PROCESSING DEVICE

(71) Applicant: SUMITOMO HEAVY INDUSTRIES, LTD., Tokyo (JP)

(72) Inventor: Susumu AIZAWA, Kanagawa (JP)

(21) Appl. No.: 17/812,779

(22) Filed: Jul. 15, 2022

Related U.S. Application Data
(63) Continuation of application No. PCT/JP2021/002079, filed on Jan. 21, 2021.

(30) Foreign Application Priority Data
Jan. 24, 2020 (JP) 2020-010201

(51) Int. Cl. E02F 9/20; E02F 9/26

(52) U.S. Cl. CPC E02F 9/205; E02F 9/262; E02F 9/265

(57) ABSTRACT

A work machine includes one or more processors; and a memory device storing a program, wherein when executed by the one or more processors, causes a computer of the work machine to perform a process including prompting an operator to perform a safety check around the work machine at intervals of a predetermined time when the operator has not performed the safety check around the work machine for more than the predetermined time.

### CROSS-REFERENCE TO RELATED APPLICATIONS

This application is a continuation application filed under 35 U.S.C. 111 (a) claiming benefit under 35 U.S.C. 120 and 365(c) of PCT International Application No. PCT/JP2021/002079, filed on Jan. 21, 2021, and designating the U.S., which claims priority to Japanese Patent Application No. 2020-010201 filed on Jan. 24, 2020. The entire contents of the foregoing applications are incorporated herein by reference.

### BACKGROUND

### Technical Field

The present disclosure relates to a work machine and the like.

### Description of Related Art

For example, a technology is known in which, when a monitoring subject such as a worker or the like enters within a close range around a work machine, such as a shovel and the like, an alarm is output and an operator is prompted to check that the monitoring subject is present outside the above-described range when the work is started.

### SUMMARY

According to an embodiment of the present disclosure, there is provided a work machine that includes one or more processors; and a memory device storing a program, wherein when executed by the one or more processors, causes a computer of the work machine to perform a process including prompting an operator to perform a safety check around the work machine at intervals of a predetermined time when the operator has not performed the safety check around the work machine for more than the predetermined time.

According to another embodiment of the present disclosure, there is provided an information processing device that includes a communication device configured to receive from a work machine image information from an imaging device that images views around the work machine, or image information of at least one of a side or a rear side of the work machine generated based on an output of the imaging device; a display device configured to display the image information representing at least one view of the side or the rear side of the work machine based on the image information received by the communication device; and an operation device configured to receive a remote-control operation relating to the work machine, wherein the communication device transmits a signal relating to an operation condition of the operation device operated by an operator to the work machine, and wherein the operator who performs the remote-control operation is prompted to check the image information displayed on the display device at intervals of a predetermined time.

According to still another embodiment of the present disclosure, there is provided an information processing device that includes a communication device configured to receive from a work machine image information from an imaging device that images views around the work machine, or image information of at least one of a side or a rear side of the work machine generated based on an output of the imaging device; and a display device configured to display the image information representing at least one view of the side or the rear side of the work machine based on the image information received by the communication device, wherein an observer who monitors the work machine operating with automatic operation is prompted to check the image information displayed on the display device at intervals of a predetermined time.

### BRIEF DESCRIPTION OF THE DRAWINGS

FIG. 1 is a schematic diagram illustrating an example of a shovel management system.

FIG. 2 is a top view illustrating an example of a shovel.

FIG. 3 is a block diagram illustrating an example of a configuration of a shovel management system.

FIG. 4 is a block diagram illustrating another example of a configuration of a shovel management system.

FIG. 5 is a flowchart schematically illustrating a first example of a control process by a controller.

FIG. 6 is a flowchart schematically illustrating a second example of a control process by the controller.

FIG. 7 is a flowchart schematically illustrating a third example of a control process by the controller.

### DETAILED DESCRIPTION

For example, a technology is known in which, when a monitoring subject such as a worker or the like enters within a close range around a work machine, such as a shovel and the like, an alarm is output and an operator is prompted to check that the monitoring subject is present outside the above-described range when the work is started.

However, when the monitoring subject is not detected for some reasons despite the presence of the monitoring subject within the close range around the work machine, the operator may continue the work without noticing the presence of the monitoring subject.

Accordingly, in view of the above, it is desirable to provide a technology capable of improving the safety of the work machine.

Hereinafter, an embodiment will be described with reference to the accompanying drawings.

[Overview of the Shovel Management System]

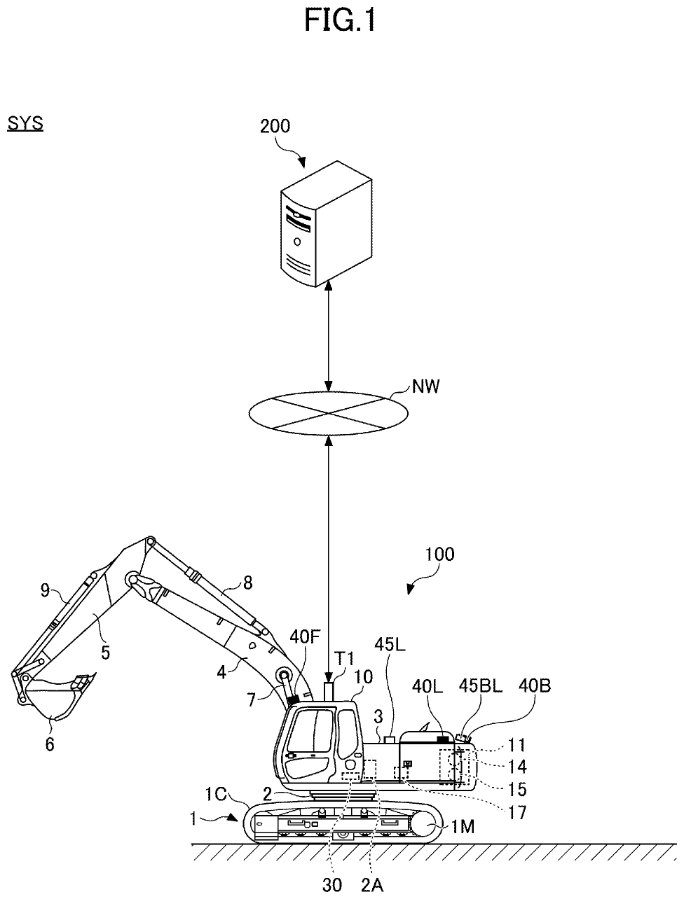

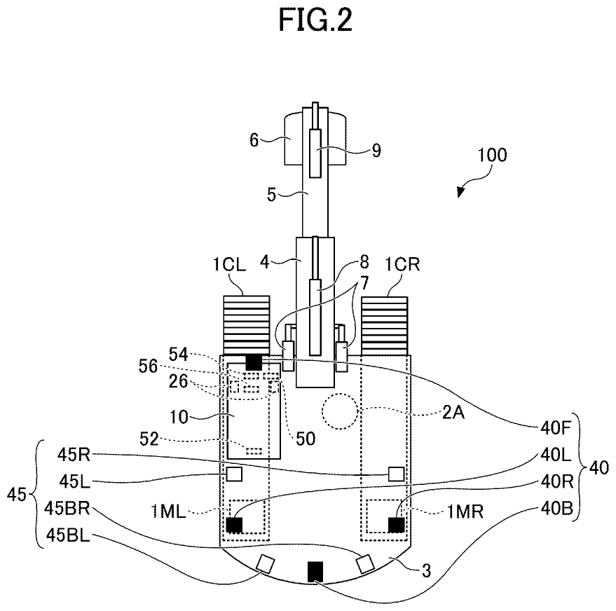

First, an outline of a shovel management system SYS according to a present embodiment will be described with reference to FIGS. 1 and 2.

FIG. 1 is a schematic diagram illustrating an example of a shovel management system SYS according to the present embodiment. FIG. 2 is a top view illustrating an example of a shovel 100 according to the present embodiment.

As illustrated in FIG. 1, the shovel management system SYS includes a shovel 100 and a management device 200.

The shovel management system SYS may include a single shovel 100 or multiple shovels 100. Similarly, the shovel management system SYS may include multiple management devices 200. That is, a process relating to the shovel management system SYS may be performed by the multiple management devices 200 in a distributed manner. For example, each of the multiple management devices 200 may communicate with a corresponding portion of the multiple shovels 100 assigned for operations, and perform a processing with respect to the corresponding portion of the shovels 100.

<Overview of Shovel>

As illustrated in FIGS. 1 and 2, a shovel 100 (an example of a work machine) according to the present embodiment includes a lower traveling body 1, an upper turning body 3 turnably mounted on the lower traveling body 1 via a turning mechanism 2, a boom 4, an arm 5, a bucket 6, and a cabin 10. The boom 4, the arm 5, and the bucket 6 constitute an attachment (implement).

The lower traveling body 1 includes a pair of right and left crawlers 1C. The crawlers 1C are hydraulically driven by the left and right hydraulic traveling motors 1M, respectively, to cause the shovel 100 to travel. That is, the crawler 1C includes a left crawler 1CL and a right crawler 1CR, and the hydraulic traveling motor 1M includes a left hydraulic traveling motor 1ML and a right hydraulic traveling motor 1MR.

The upper turning body 3 is driven by the hydraulic turning motor 2A to turn with respect to the lower traveling body 1.

The boom 4 is pivotally attached to the front center of the upper turning body 3 to be able to pivot vertically. The arm 5 is pivotally attached to the end of the boom 4 to be able to pivot vertically. The bucket 6 is pivotally attached to an end of the arm 5 to be able to pivot vertically. The boom 4, the arm 5, and the bucket 6 are hydraulically driven by a boom cylinder 7, an arm cylinder 8, and a bucket cylinder 9, respectively, serving as hydraulic actuators. The bucket 6 is an example of an end attachment, and the end of the arm 5 may be fitted with another end attachment, such as a slope bucket, a dredging bucket, a breaker, or the like, instead of the bucket 6, depending on work contents and the like.

At least some of the lower traveling body 1, the upper turning body 3, the boom 4, the arm 5, and the bucket 6 may be driven by an electric actuator instead of a hydraulic actuator. For example, the upper turning body 3 may be electrically driven by an electric motor instead of the hydraulic turning motor 2A.

The cabin 10 is an operator's cab and is mounted on the front left side of the upper turning body 3.

The shovel 100 according to the present embodiment includes a communication device T1 and is communicatively connected to the management device 200 via a predetermined communication network NW. The predetermined communication network may include, for example, a mobile communication network with a base station as a terminal, a satellite communication network using a communication satellite, the Internet, and the like. The communication network NW may be a wireless communication network based on a near field wireless communication standard such as Bluetooth (registered trademark) or WiFi. Accordingly, the shovel 100 can transmit (upload) information acquired by the shovel 100 itself to the management device 200.

The shovel 100 operates driven elements, such as the lower traveling body 1 (crawlers 1CL and 1CR), the upper turning body 3, the boom 4, the arm 5, and the bucket 6, according to the operation of an operator in the cabin 10.

Further, the shovel 100 may be configured to be operable by an operator in the cabin 10, or may be configured to be remotely controlled (remote-control operation) from the outside of the shovel 100. When the shovel 100 is remotely controlled, the inside of the cabin 10 is unmanned. The following description assumes that an operator's operation includes at least one of an operation by the operator in the cabin 10 with respect to an operation device 26 and/or a remote-control operation by an external operator.

The remote-control operation includes a mode in which the shovel 100 is operated, for example, according to an operational input relating to an actuator of the shovel 100 performed by a predetermined external device. The predetermined external device is, for example, a management device 200. In this case, for example, the shovel 100 transmits image information (captured images) output by an imaging device 40 to the management device 200, and the image information may be displayed on a display device 230A disposed in the management device 200. Various information images (information screens) displayed on a display device 50 inside the cabin 10 of the shovel 100 may also be displayed on the display device 230A of the management device 200. Accordingly, the operator of the management device 200 can remotely control the shovel 100 while checking the display contents such as the captured images, the information screens, or the like representing views of the surroundings of the shovel 100 displayed on the display device 230A. The shovel 100 may operate the hydraulic actuators according to remote-control signals representing remote-control contents received by the communication device T1 described below from the management device 200 to drive the driven elements such as the lower traveling body 1 (the crawlers 1CL and 1CR), the upper turning body 3, the boom 4, the arm 5, and the bucket 6.

The remote-control operation may also include a mode in which the shovel 100 is operated, for example, by an external voice input or gesture input to the shovel 100 from a person (e.g., a worker) around the shovel 100. Specifically, the shovel 100 recognizes a voice spoken by a nearby operator or the like through a voice input device (e.g., a microphone), or a gesture performed by a worker or the like through a gesture input device (e.g., an imaging device). The voice input device and the gesture input device are mounted on the shovel 100 (itself). The shovel 100 may operate an actuator according to the contents of the recognized voice, gesture, or the like to drive the driven elements such as the lower traveling body 1 (the crawler 1CL and 1CR), the upper turning body 3, the boom 4, the arm 5, and the bucket 6.

The shovel 100 may also automatically operate the actuators regardless of the operator's operation contents. Thus, the shovel 100 provides a function (so-called an “automatic operation function” or a “machine control function”) to automatically operate at least some of the driven elements such as the lower traveling body 1, the upper turning body 3, the boom 4, the arm 5, and the bucket 6.

The automatic operation function may include a function to automatically operate a driven element (actuator) other than the driven element (actuator) to be operated according to the operator's operation or remote-control operation with respect to the operation device 26 (a so-called “semi-automatic operation function” or “operation-assisted machine control function”). The automatic operation function may also include a function to automatically operate at least some of the multiple driven elements (hydraulic actuators) (so-called “full-automatic operation function”) without the operator's operation or remote-control operation with respect to the operation device 26. In the shovel 100, when a full-automatic operation function is enabled, the inside of the cabin 10 may be unmanned. In addition, the semi-automatic operation function, the full-automatic operation function, or the like may include a mode in which operation contents of a driven element (actuator) subject to automatic operation are automatically determined according to a predetermined rule. Further, the semi-automatic operation function, the full-automatic operation function, or the like may include a mode in which the shovel 100 autonomously makes various judgments and autonomously determines operation contents of the driven element (hydraulic actuator) subject to automatic operation based on the judgment results (so-called “autonomous operation function”).

<Overview of Management Device>

The management device 200 (an example of an information processing device) is, for example, connected to the shovel 100 to be in communication with the management device 200 via a predetermined communication network NW, and manages (monitors) a condition and operation of the shovel 100 based on various information received from the shovel 100. The management device 200 also supports, for example, the remote-control operation of the shovel 100. The management device 200 also supports remote monitoring of the shovel 100 which operates by an automatic operation function (typically a full-automatic operation function) executed, for example, by a user such as a manager or an operator. Hereinafter, a user who monitors the shovel 100 by a remote-control function may be referred to as an “observer”.

The management device 200 is, for example, a cloud server located at a management center external to the work site of the shovel 100. The management device 200 may also be, for example, an edge server installed in a location relatively close to the shovel 100 (e.g., a management office within a work site or a radio base station or station building relatively close to a work site). The management device 200 may be a terminal device (e.g., a desktop-type computer terminal) that is installed (stationary) in a management office or the like within a work site of the shovel 100. The management device 200 may be a portable terminal (for example, a smartphone, a tablet terminal, a laptop computer terminal, or the like) which can be carried by the manager or the like of the shovel 100.

[Configuration of Shovel Management System]

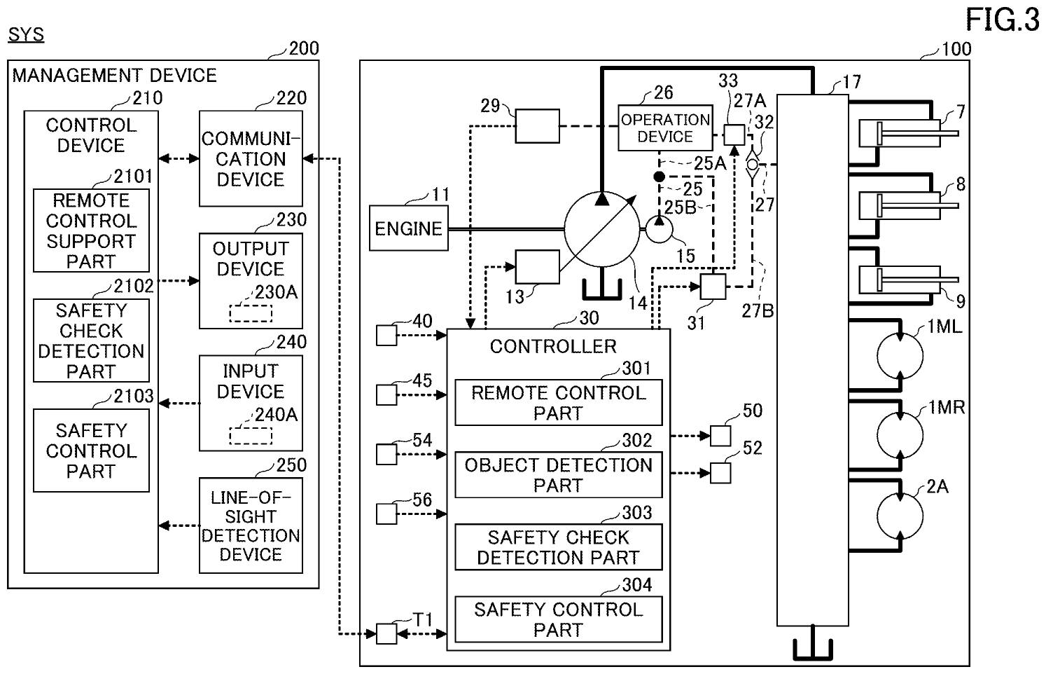

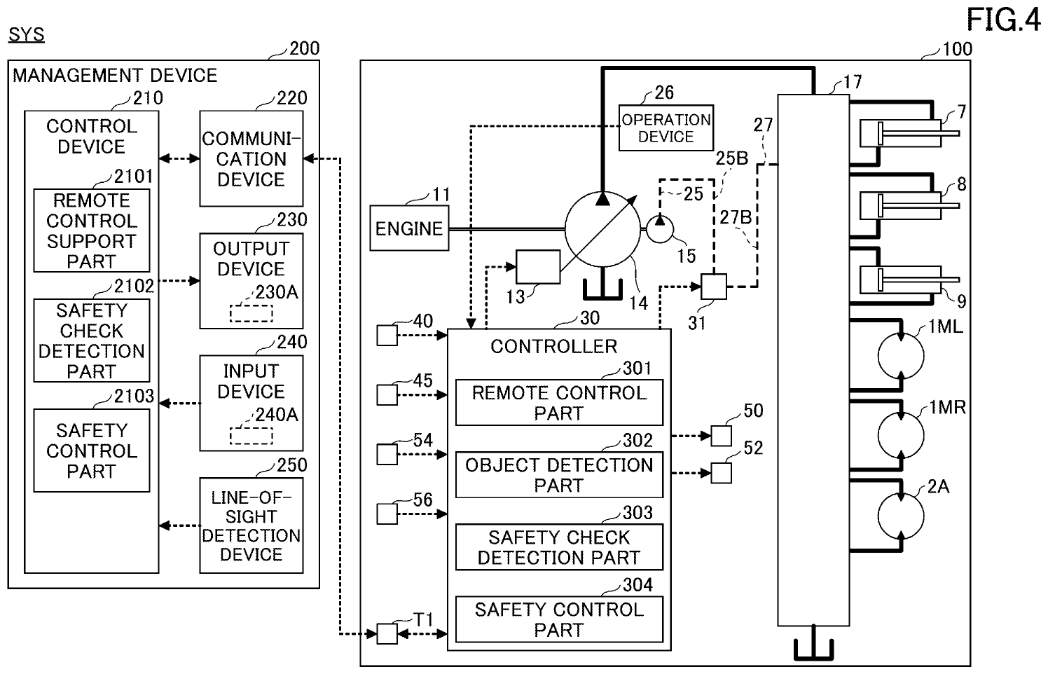

Next, a specific configuration of the shovel management system SYS according to the present embodiment will be described with reference to FIGS. 3 and 4 in addition to FIGS. 1 and 2.

FIGS. 3 and 4 are block diagrams schematically illustrating one example and another example of the configuration of the shovel management system SYS according to the present embodiment, respectively. In FIGS. 3 and 4, the configurations of the management device 200 are the same as each other, and only the configurations of the shovel 100 are different from each other.

Note that in FIGS. 3 and 4, mechanical power lines, hydraulic oil lines, pilot lines, and electrical signal lines are illustrated as double lines, thick solid lines, dashed lines, and dotted lines, respectively.

<Configuration of Shovel>

As illustrated in FIGS. 3 and 4, a hydraulic drive system of the shovel 100 according to the present embodiment includes hydraulic actuators such as hydraulic traveling motors 1ML and 1MR, a hydraulic turning motor 2A, a boom cylinder 7, an aim cylinder 8, and a bucket cylinder 9 as described above. The hydraulic drive system of the shovel 100 according to the present embodiment includes an engine 11, a regulator 13, a main pump 14, and a control valve 17.

The engine 11 is the main power source (motor) in the hydraulic drive system. The engine 11 is, for example, a diesel engine fueled with diesel oil. The engine 11 is mounted, for example, on the rear side of the upper turning body 3 and rotates at a predetermined target speed, under direct or indirect control of a controller 30 to drive the main pump 14 and the pilot pump 15.

Note that the motor of the shovel 100 may be an electric motor driven by a built-in power storage device or power supplied from an external source, instead of, or in addition to, the engine 11.

The regulator 13 adjusts the discharge amount of the main pump 14. For example, the regulator 13 adjusts the angle (tilt angle) of a swash plate of the main pump 14 in response to control instructions from the controller 30.

The main pump 14, for example, like the engine 11, is mounted on the rear side of the upper turning body 3 to supply hydraulic oil to the control valve 17 through a high pressure hydraulic line. The main pump 14 is driven by the engine 11 as described above. The main pump 14 is, for example, a variable displacement hydraulic pump, and as described above, under the control of the controller 30, the regulator 13 adjusts the tilt angle of the swash plate, thereby adjusting the stroke length of the piston and controlling the discharge flow rate.

The control valve 17 is a hydraulic control device that controls the hydraulic drive system in response to an operator's operation. The control valve 17 is mounted, for example, in the center of the upper turning body 3. The control valve 17 selectively supplies hydraulic oil supplied from the main pump 14 to the multiple hydraulic actuators, according to the operation or remote-control operation of the operation device 26. The control valve 17 includes multiple control valves (also referred to as directional switching valves) for controlling a flow rate and flow direction of hydraulic oil supplied from the main pump 14 to each of the multiple hydraulic actuators.

The multiple control valves (directional switching control valves) are, for example, spool valves that respectively supply hydraulic oil supplied from the main pump 14 to the hydraulic actuators and discharge hydraulic oil discharged by the hydraulic actuators to a hydraulic oil tank. Specifically, each control valve may be configured to move a spool in two opposite directions from a neutral position, and the direction of movement of the spool may determine a flow direction of hydraulic oil of a hydraulic actuator, i.e., the operation direction of the hydraulic actuator.

As illustrated in FIGS. 3 and 4, an operating system of the shovel 100 according to the present embodiment includes a pilot pump 15, an operation device 26, a controller 30, and a hydraulic control valve 31. As illustrated in FIG. 3, the operating system of the shovel 100 according to the present embodiment includes a shuttle valve 32 and a hydraulic control valve 33 when the operation device 26 is a hydraulic pilot type.

The pilot pump 15, for example, is mounted on a rear side of the upper turning body 3 to supply a pilot pressure to various hydraulic devices of the operation device 26 and the like via a pilot line 25. The pilot pump 15 is, for example, a fixed displacement hydraulic pump driven by the engine 11 as described above.

The operation device 26 is provided near an operator's seat in the cabin 10 and is used by an operator to operate each of the multiple driven elements of the shovel 100. The multiple driven elements include, for example, a lower traveling body 1, an upper turning body 3, a boom 4, an aim 5, and a bucket 6. In other words, the operation device 26 is used by an operator to operate multiple hydraulic actuators which drive respective driven elements. The multiple hydraulic actuators include, for example, hydraulic traveling motors 1ML and 1MR, a hydraulic turning motor 2A, a boom cylinder 7, an aim cylinder 8, and a bucket cylinder 9 as described above.

The operation device 26 includes, for example, lever devices configured to operate a pair of crawlers (hydraulic traveling motors 1ML and 1MR) of the lower traveling body 1, the boom 4 (boom cylinder 7), the aim 5 (arm cylinder 8), the bucket 6 (bucket cylinder 9), and the upper turning body 3 (hydraulic turning motor 2A), respectively.

As illustrated in FIG. 3, the operation device 26 is, for example, a hydraulic pilot system that outputs hydraulic oil having a pilot pressure corresponding to its operation. Specifically, the operation device 26 uses the hydraulic oil supplied from the pilot pump 15 through the pilot line 25 and a pilot line 25A branched from the pilot line 25 to output a pilot pressure to a pilot line 27A on the secondary side of the operation device 26, according to contents of the operation. The pilot line 27A is connected to an inlet port of the shuttle valve 32, and is connected to the control valve 17 via the pilot line 27 connected to an outlet port of the shuttle valve 32. This enables the control valve 17 to receive a pilot pressure via the shuttle valve 32 according to operations of the various driven elements (i.e., hydraulic actuators) in the operation device 26. Accordingly, the control valve 17 is capable of driving the hydraulic actuators according to the operator's operation contents or the like with respect to the operation device 26.

Also, as illustrated in FIG. 4, the operation device 26 is, for example, an electric type. Specifically, the operation device 26 outputs an electrical signal (hereinafter referred to as an “operation signal”) according to the operation contents, and the operation signal is incorporated into the controller 30. The controller 30 outputs to the hydraulic control valve 31 a control instruction corresponding to contents of the operation signal, i.e., a control signal corresponding to the operation contents of the operation device 26. Thus, a pilot pressure corresponding to the operation contents of the operation device 26 is input from the hydraulic control valve 31 to the control valve 17, and the control valve 17 is capable of driving the respective hydraulic actuators according to the operation contents of the operation device 26.

The control valves (directional switching control valves) that drive the respective hydraulic actuators built in the control valve 17 may be a solenoid type spool valve. In this case, an operation signal output from the operation device 26 may be directly input to the control valve 17, i.e., an electromagnetic solenoid type control valve.

The hydraulic control valve 31 is provided for each of the driven elements (hydraulic actuators) to be operated by the operation device 26. That is, the hydraulic control valve 31 is provided, for example, for each of the crawler 1CL (the hydraulic traveling motor 1ML), the crawler 1CR (the hydraulic traveling motor 1MR), the upper turning body 3 (the hydraulic turning motor 2A), the boom 4 (the boom cylinder 7), the arm 5 (the arm cylinder 8), and the bucket 6 (the bucket cylinder 9). The hydraulic control valve 31 is provided, for example, in a pilot line 25B between the pilot pump 15 and the control valve 17. The hydraulic control valve 31 may be configured, for example, to change its flow path area (i.e., a cross-sectional area through which the hydraulic fluid is allow to flow). This enables the hydraulic control valve 31 to use the hydraulic oil of the pilot pump supplied through the pilot line 25B to output a predetermined pilot pressure to a pilot line 27B on the secondary side of the hydraulic control valve 31. Thus, as illustrated in FIG. 3, the hydraulic control valve 31 indirectly applies a predetermined pilot pressure to the control valve 17 in response to a control signal from the controller 30 through the shuttle valve 32 between the pilot line 27B and the pilot line 27. Further, as illustrated in FIG. 4, unlike in FIG. 3, the pilot line 27A and the shuttle valve 32 are omitted, and the hydraulic control valve 31 can directly apply a predetermined pilot pressure to the control valve 17 in response to a control signal from the controller through the pilot line 27B and the pilot line 27. Accordingly, the controller 30 can supply a pilot pressure from the hydraulic control valve 31 to the control valve 17 according to the operation contents of the electric operation device 26 to implement the operation of the shovel 100 based on the operator's operation.

More specifically, two hydraulic control valves 31 are provided, for example, for each of multiple driven elements (hydraulic actuators). The two hydraulic control valves 31 are respectively connected, via the shuttle valve 32 and the pilot line 27, to two pilot ports of the control valve (directional switching valve) for moving the spool in the first and second directions. This enables the controller 30 to operate the hydraulic actuator subject to operation in a desired direction by outputting a control signal to one of the two hydraulic control valves 31. The following illustrates on the assumption that the movement of the spool in the first direction corresponds to the operation of the hydraulic actuator (driven element) in the first direction and the movement of the hydraulic actuator (driven element) in the first direction. The same applies for the movement of the spool in the second direction. The respective pilot ports to which pilot pressures are supplied to move the spool of the control valve (directional switching control valve) in the first direction and the second direction may also be referred to as a “first pilot port” and a “second pilot port”.

The controller 30 also controls, for example, the hydraulic control valve 31 to remotely control the shovel 100. Specifically, the controller 30 outputs to the hydraulic control valve 31 control signals corresponding to the remote-control contents specified by the remote-control signals received from the management device 200. This enables the controller 30 to supply a pilot pressure corresponding to the remote-control contents from the hydraulic control valve to the control valve 17, thereby implementing the operation of the shovel 100 based on the remote-control operation performed by the operator.

As illustrated in FIG. 3, the shuttle valve 32 includes two inlet ports and one output port, and is configured to output, from the output port, a hydraulic oil having a higher pilot pressure from among the pilot pressures applied to the two inlet ports. The shuttle valve 32 is provided for each of the driven elements (hydraulic actuators) to be operated by the operation device 26. That is, the shuttle valve 32 is provided, for example, for each of the crawler 1CL (the hydraulic traveling motor 1ML), the crawler 1CR (the hydraulic traveling motor 1MR), the upper turning body 3 (the hydraulic turning motor 2A), the boom 4 (the boom cylinder 7), the arm 5 (the arm cylinder 8), and the bucket 6 (the bucket cylinder 9). One of the two inlet ports of the shuttle valve 32 is connected to the pilot line 27A on the secondary side of the operation device 26 (specifically, the lever devices described above included in the operation device 26), and the other of the two inlet ports of the shuttle valve 32 is connected to the pilot line 27B on the secondary side of the hydraulic control valve 31. The outlet port of the shuttle valve 32 is connected through the pilot line 27 to the pilot port of a corresponding control valve 17. The corresponding control valve represents a control valve that drives a hydraulic actuator to be operated by the lever devices described above, which is connected to one of the inlet ports of the shuttle valve 32. Thus, each of the shuttle valves 32 can apply a higher one of the pilot pressure in the pilot line 27A on the secondary side of the operation device 26 (lever devices) and the pilot pressure in the pilot line 27B on the secondary side of the hydraulic control valve 31 to the pilot port of the corresponding control valve. In other words, the controller can control the corresponding control valve without relying on the operator's operation with respect to the operation device 26 by causing the hydraulic control valve 31 to output a pilot pressure higher than the pilot pressure of the pilot line 27A on the secondary side of the operation device 26. Accordingly, the controller 30 can control the operation of the driven elements (the crawlers 1CL and 1CR, the upper turning body 3, the boom 4, the arm 5, and the bucket 6) to implement a remote-control function of the shovel 100 regardless of the operator's operation condition with respect to the operation device 26.

More specifically, two shuttle valves 32 are provided, for example, for each of the multiple driven elements (hydraulic actuators). One inlet port of each of the two shuttle valves 32 is connected to a corresponding pilot line of the two pilot lines 27A, corresponding to operations of the lever devices in opposite first and second directions. The other inlet port of each of the two shuttle valves 32 is connected to the corresponding pilot line of the pilot lines 27B on the secondary side of the two hydraulic control valves 31, as described above. The outlet ports of the two shuttle valves 32 are respectively connected to the first and second pilot ports of the control valve through the pilot line 27. This provides pilot pressure from one of the two shuttle valves 32 to the first pilot port or the second pilot port of the control valve, allowing a hydraulic actuator to be operated in a desired direction (first direction or second direction).

As illustrated in FIG. 3, the hydraulic control valve 33 is disposed on the pilot line 27A connecting the operation device 26 (the lever devices) and the shuttle valve 32. The hydraulic control valve 33 is configured to, for example, change the flow area thereof. The hydraulic control valve 33 operates in response to control signals input from the controller 30. This enables the controller 30 to forcibly depressurize the pilot pressure output from the operation device 26 when the operation device 26 is operated by an operator. Accordingly, even when the operation device 26 is operated, the controller 30 may forcibly restrict or stop the operation of the hydraulic actuator corresponding to the operation of the operation device 26. The controller 30, for example, can depressurize the pilot pressure output from the operation device 26 even when the operation device 26 is operated to lower the pressure below the pilot pressure output from the hydraulic control valve 31. Thus, the controller 30 can control the hydraulic control valve 31 and the hydraulic control valve 33, for example, to ensure that the desired pilot pressure is applied to the pilot port of the control valve in the control valve 17 regardless of the operation contents of the operation device 26. Accordingly, the controller 30 can more appropriately provide the remote-control function of the shovel 100 by controlling the hydraulic control valve 33 in addition to the hydraulic control valve 31.

More specifically, two hydraulic control valves 33 are provided, for example, for each of the multiple driven elements (hydraulic actuators). The two hydraulic control valves 33 are provided for the two pilot lines 27A corresponding to operations of the lever device in opposite first and second directions. Thus, even when the lever device is operated in any one of the first direction or the second direction, the two hydraulic control valves 33 are able to depressurize the pilot pressure of the corresponding pilot line 27A.

Note that the hydraulic control valve 33 may be omitted. The controller 30 may also control the hydraulic control valve 31 corresponding to an operation of a hydraulic actuator in the second direction in order to restrict or stop the operation of the driven element (hydraulic actuator) in the first direction based on the operator's operation regardless of the presence or the absence of the hydraulic control valve 33. Thus, a pilot pressure is supplied from the hydraulic control valve 31 through the shuttle valve 32 to a second pilot port of the control valve corresponding to the hydraulic actuator. Thus, pilot pressure can be applied to the second pilot port of the control valve in opposition to the pilot pressure acting on the first pilot port of the control valve in response to the operator's operation. Accordingly, it is possible to bring the spool of the control valve closer to a neutral condition to restrict the operation of the hydraulic actuator. The controller 30 may also control the hydraulic control valve 31 corresponding to the operation of the hydraulic actuator in the first direction in order to restrict or stop the operation of the driven element (hydraulic actuator) in the second direction based on the operator's operation regardless of the presence or the absence of the hydraulic control valve 33. Further, the pilot line 27B of FIG. 4 may be provided with the hydraulic control valve 33 of FIG. 3. Thus, the controller 30 can forcibly depressurize the pilot pressure output from the hydraulic control valve 31 when the operation device 26 is operated by the operator. Thus, the controller 30 can forcibly restrict or stop the operation of the hydraulic actuator corresponding to the operation of the operation device 26 even when the pilot pressure corresponding to the operation contents of the operation device 26 is output from the hydraulic control valve 31.

As illustrated in FIGS. 3 and 4, the control system of the shovel 100 according to the present embodiment includes the controller 30, the imaging device 40, a peripheral object information acquisition device 45, a display device 50, a sound output device 52, an input device 54, a line-of-sight detection device 56, and a communication device T1. As illustrated in FIG. 3, the control system of the shovel 100 according to the present embodiment includes an operation pressure sensor 29 when the operation device 26 is a hydraulic pilot type.

The controller 30 is disposed, for example, in the cabin 10 to perform various controls with respect to the shovel 100. The controller 30 may implement its functions in any given hardware or any given combination of hardware and software. For example, the controller 30 is mainly constituted by a computer including one or more processors such as a CPU (Central Processing Unit), a memory device such as a RAM (Random Access Memory), a nonvolatile auxiliary storage device such as a ROM (Read Only Memory), external I/O interface devices, and the like. The controller 30 may also include high-speed computing circuitry, such as a GPU (Graphics Processing Unit), an ASIC (Application Specific Integrated Circuit), and an FPGA (Field-Programmable Gate Array), which operate with the CPU. The controller 30 performs various functions by, for example, loading various programs installed in the auxiliary storage device onto the memory device and executing the loaded various programs by the CPU.

The controller 30 is, for example, configured to perform controls relating to the engine 11 and the main pump 14.

The controller 30 records log information (hereinafter simply referred to as “log information”) relating to various conditions of the shovel 100, for example, in an auxiliary storage device or a communicatively connected external storage device. The log information may include, for example, information indicating that a predetermined operation on the shovel 100 has been performed. The log information may also include, for example, information indicating that a predetermined operation or a predetermined work has been performed by the shovel 100. The log information may also include, for example, information indicating that the shovel 100 has fallen into a predetermined static or dynamically unstable condition. The log information may also be transmitted to the management device 200. A user of the management device 200 may check such log information of the one or more shovels 100.

The controller 30 further includes, for example, a remote control part 301, an object detection part 302, a safety check detection part 303, and a safety control part 304 as functional parts.

The imaging device 40 (an example of a surrounding condition information acquisition device) is mounted on an upper portion of the upper turning body 3, and is configured to capture images of surroundings of the shovel 100 extending from an area relatively close to the shovel 100 to an area relatively far away from the shovel 100 to acquire the captured images. The imaging device 40 includes cameras 40F, 40B, 40L, and 40R. Hereinafter, cameras 40F, 40B, 40L, and 40R may be referred to collectively or separately as a “camera 40X”.

The camera 40F, the camera 40B, the camera 40L, and the camera 40R are mounted on a front side top, a rear side top, a left top, and a right top of the upper turning body 3, respectively, to image the front, rear, left side, and right side of the upper turning body 3. For example, the camera 40X is a monocular camera (i.e., a wide angle camera) having a very wide field angle. For example, the camera 40X may be a stereo camera, a range image camera, a depth camera, or the like. The camera 40F captures an imaging range ahead of the upper turning body 3, such as an imaging range in the horizontal direction (i.e., a circumferential direction viewing from the shovel 100) extending from the left front side to the right front side of the upper turning body 3. In addition, the camera 40B captures an imaging range behind the upper turning body 3, such as an imaging range in the horizontal direction (that is, a circumferential direction viewing from the shovel 100) extending from the left rear side to the right rear side of the upper turning body 3. The camera 40L, for example, images an imaging range on the left side of the upper turning body 3, such as an imaging range in the horizontal direction (in a circumferential direction viewing from the shovel 100) from the left front side to the left rear side of the upper turning body 3. The camera 40R, for example, captures an imaging range on the right side of the upper turning body 3, such as an imaging range in the horizontal direction (in a circumferential direction viewing from the shovel 100) from the right front side to the right rear side of the upper turning body 3. The camera 40X is mounted so that the optical axis is obliquely downward at the upper portion of the upper turning body 3, and images an imaging range in the vertical direction including the distance from the ground plane near the shovel 100 to the shovel 100.

The camera 40X outputs, for example, an image every predetermined period (e.g., 1/30 seconds) from the start (i.e., key switch ON) of the shovel 100 to the stop (i.e., key switch OFF). The image output from the camera 40X is loaded into the controller 30. The image output from the camera 40X may be transmitted (uploaded) from the controller 30 to the management device 200 through the communication device T1.

The peripheral object information acquisition device 45 (an example of the surrounding condition information acquisition device) is mounted on the upper portion of the upper turning body 3 and acquires information about an object around the shovel 100. The peripheral object information acquisition device 45 includes sensors 45BL, 45BR, 45L, and 45R. The sensors 45BL, 45BR, 45L, and 45R may hereinafter be referred to collectively or separately as a “sensor 45X”.

The sensors 45BL, 45BR, 45L, and 45R are mounted on the left-most rear end, the right-most rear end top, the left-most top, and the right-most top of the upper turning body 3, respectively, to obtain information about the left-rear, right-rear, left-side, and right-side conditions of the upper turning body 3. For example, the sensor 45X is LIDAR (Light Detection and Ranging). For example, the sensor 45X may be, for example, a millimeter wave radar, an ultrasonic sensor, or the like. Hereinafter, the description will be focused on the case where the sensor 45X is LIDAR.

The sensor 45X acquires information about an object around the shovel 100, specifically, information about received reflected light (hereinafter referred to as “received light information”), for example, by emitting infrared light in a certain direction and receiving the reflected light from an object in that direction. The sensor 45X is, for example, a scanning LIDAR which is a three-dimensional laser scanner capable of scanning in the direction of the infrared laser in the up-down and left-right directions. The sensor 45X may also be a so-called flash-type LIDAR that emits infrared light from a light emitting module over a wide area of three dimensions and captures reflected light (infrared light) by a three-dimensional range image element.

The received light information includes information on the time from the emission of infrared light to the reception of reflected light (TOF: Time of Flight) for each emission direction of infrared light (hereinafter referred to as “TOF information”), and information on the intensity of reflected light received for each emission direction of infrared light (hereinafter referred to as “received light intensity information”).

The sensor 45BL is configured to be capable of emitting infrared light in an emission range on the left rear side of the upper turning body 3, for example, in the emission range in a horizontal direction (i.e., in a circumferential direction viewing from the shovel 100) extending from the left rear side to the rear side of the upper turning body 3. The sensor 45BR is configured to be capable of emitting infrared light in an emission range on the right rear side of the upper turning body 3, for example, in an emission range in the horizontal direction (in a circumferential direction viewing from the shovel 100) extending from the right rear side to the rear side of the upper turning body 3. The sensor 45L is configured to be capable of emitting infrared light in an emission range on the left side of the upper turning body 3, for example, in an emission range in the horizontal direction (in a circumferential direction viewing from the shovel 100) extending from the left front side to the left rear side of the upper turning body 3. The sensor 45R is configured to be capable of emitting infrared light in an emission range on the right side of the upper turning body 3, for example, in an emission range from the right front side to the right rear side of the upper turning body 3. The sensor 45X is mounted so that the optical axis (i.e., a reference axis in an emission direction of the infrared light) is obliquely downward at the upper portion of the upper turning body 3, and has an emission range in a vertical direction centered on the portion of the ground that is relatively close to the shovel 100.

Each sensor 45X outputs received light information every predetermined period from the start to the stop of the shovel 100. The received light information output from the sensor 45X is loaded into the controller 30.

The display device 50 is installed in a location within the cabin 10 that is readily viewable from a seated operator and displays various information images under the control of the controller 30. The display device 50 may be, for example, a liquid crystal display or an organic EL (Electroluminescence) display. This enables the display device 50 to notify the operator of visual information.

The display device 50 displays images representing views around the shovel 100 (hereinafter referred to as “peripheral images”) based, for example, on the images captured by the imaging device 40. The peripheral images may be image information itself around the shovel 100 imaged by the imaging device 40, or the peripheral images may be processed images generated by applying known image processing (e.g., viewpoint conversion processing) to the image information. The peripheral images also include at least one view of the left side, the right side, and the rear side of the upper turning body 3, for example. Accordingly, an operator in the cabin 10 is able to check the left side, the right side, and the rear side of the upper turning body 3, each of which is an area that is likely to be a blind spot (hereinafter referred to as a “blind spot area”) during normal operation of the shovel 100, by checking the peripheral images displayed on the display device 50.

The sound output device 52 is disposed within the cabin 10 to output sound under the control of the controller 30. The sound output device 52 may be, for example, a buzzer or a speaker. Thus, the sound output device 52 is able to notify the operator of the auditory information according to the content of the output sound (tone, sound pressure, sound pattern, voice content, etc.).

The input device 54 is positioned within reach of a seated operator in the cabin 10 for receiving various inputs from the operator and outputting signals in response to the inputs to the controller 30. For example, the input device 54 includes an operation input device that receives an operation input from the operator. The operation input device may include, for example, a touch panel mounted on a display of the display device 50. The operation input device may also include, for example, a touch pad, a button switch, a lever, a toggle, or the like located around the display device 50. The operation input device may also include, for example, a knob switch disposed at the tip of the operation device 26 (lever device). For example, the input device 54 may include a voice input device or a gesture input device configured to receive an operator's voice input or gesture input. The voice input device includes, for example, a microphone. The gesture input device includes, for example, an imaging device configured to image an operator in the cabin 10. A signal corresponding to an input to the input device 54 is loaded into the controller 30.

The line-of-sight detection device 56 is disposed in the cabin 10 to detect an operator's line of sight. The detection information corresponding to the operator's line of sight detected by the line-of-sight detection device 56 is loaded into the controller 30.

The communication device T1 communicates with an external device (for example, the management device 200) through the communication network NW. The communication device T1 is, for example, a mobile communication module connected to a mobile communication network having a base station as a terminal. The communication device T1 may be, for example, a satellite communication module connected to a satellite communication network using a communication satellite. The communication device T1 may be a WiFi communication module or a Bluetooth communication module for performing near field communication.

The operation pressure sensor 29 detects a pilot pressure (operation pressure) on the secondary side corresponding to the operation contents of the operation device 26. The output of the operating pressure sensor 29 is loaded into the controller 30. Accordingly, the controller 30 can acquire the operation contents of the operation device 26.

The remote control part 301 controls the remote-control operation of the shovel 100. Specifically, as described above, the remote control part 301 controls the hydraulic control valve 31 or the hydraulic control valves 31 and 33 according to the remote-control contents specified by the remote-control signal received from the management device 200 by the communication device T1 to remotely control the shovel 100.

The object detection part 302 detects an object subject to monitoring (hereinafter simply referred to as a “monitoring subject”) in a proximity monitoring area around the shovel 100 based on the outputs of the imaging device 40 and the peripheral object information acquisition device 45. The monitoring subjects include, for example, workers around the shovel 100, supervisors at the work site, and the like. The monitoring subjects may also include any non-human objects, such as, for example, materials temporarily placed at the work site, stationary non-moving obstacles such as temporary offices at the work site, or moving obstacles such as vehicles including trucks.

The object detection part 302 detects a monitoring subject in a predetermined monitoring area (hereinafter referred to as a “first monitoring area” for convenience) around the shovel 100 (upper turning body 3) based on, for example, the output of the imaging device 40, i.e., images captured by the imaging device 40.

The object detection part 302 may detect a monitoring subject within the first monitoring area extending in a horizontal direction viewing from the shovel 100 (hereinafter simply referred to as a “horizontal direction”), i.e., along a plane (hereinafter referred to as a “work plane”) on which the shovel 100 is working (on which the lower traveling body 1 is grounded). Specifically, the object detection part 302 may detect a monitoring subject within the first monitoring area in which a horizontal distance D from the shovel 100 (upper turning body 3) is within a predetermined distance Dth1 (for example, 5 meters).

For example, the object detection part 302 recognizes a monitoring subject in the captured image by optionally applying a machine learning-based identifier including various known image processing techniques or artificial intelligence (AI), and the like.

Further, by applying various known techniques, the object detection part 302 determines (estimates) a position (for example, a foot position) at which an identified monitoring subject (a person) is present (hereinafter referred to as an “actual position”) that is reflected in the captured image by the monocular imaging device 40.

For example, the object detection part 302 estimates a horizontal distance viewing from the shovel 100 (hereinafter referred to as a “horizontal distance”) based on the identified size of the monitoring subject in the captured image (e.g., the height of the monitoring subject in the captured image). This is because there is a correlation such that the size of the monitoring subject in the captured image becomes smaller as the monitoring subject moves away from the shovel 100. Specifically, since the monitoring subject has an assumed size range (e.g., an assumed human height range), a correlation between the horizontal distance of the monitoring subject viewing from the shovel 100 included in the assumed size range and the size of the monitoring subject in the captured image may be predefined. Thus, the object detection part 302 can estimate the horizontal distance of the monitoring subject from the shovel 100 on the basis of a map, a conversion equation, or the like representing a correlation between the size of the monitoring subject in the captured image and the horizontal distance viewing from the shovel 100, which is stored in advance in an internal memory of an auxiliary storage device or the like of the controller 30. Further, the object detection part 302 can estimate the direction in which the monitoring subject is disposed from the viewpoint of the shovel 100 (camera 40X) according to the position in the lateral direction (the left and right direction) of the captured image.

For example, the object detection part 302 can estimate an actual position (for example, a foot position) of the captured image by projection transformation (nomography transformation) or the like in the same plane as the shovel 100 (specifically, the lower traveling body 1) under the assumption that the monitoring subject is in the same plane. In this case, a portion (a point) forming the captured image corresponds to a position in the same plane as the shovel 100.

Further, the object detection part 302 detects the monitoring subject in a predetermined monitoring area (hereinafter referred to as “a second monitoring area” for convenience) around the shovel 100 (the upper turning body 3) based, for example, on the output of the peripheral object information acquisition device 45 (i.e., the received light information).

The object detection part 302 may detect a monitoring subject in the second monitoring area extending in a horizontal direction, that is, extending along a work plane. Specifically, the object detection part 302 may detect a monitoring subject within the second monitoring area in which a horizontal distance D from the shovel 100 (upper turning body 3) is within a predetermined distance Dth2. The predetermined distances Dth1 and Dth2 may be the same or different. That is, the first and second monitoring areas may be the same or different. For example, the first monitoring area may include a range relatively away from the shovel 100, and the second monitoring area may be limited to a range closer to the shovel 100 than the first monitoring area.

For example, the object detection part 302 recognizes the presence of surrounding objects and their positions based on TOF (Time-of-Flight) information of the light received from the peripheral object information acquisition device 45. Further, the object detection part 302 may identify the shape of an object, the size of an object, or the like on the basis of the received light information (TOF information) corresponding to the reflected light received from multiple emission directions, thereby identifying the type of a surrounding object and determining whether or not the object corresponds to a monitoring subject. Further, the object detection part 302 may identify the type of an object by identifying the retro-reflectivity or the reflectivity of the surrounding object on the basis of the light intensity information of the received light information, and determine whether or not the object corresponds to the monitoring subject.

The object detection part 302, for example, transmits a signal representing that a monitoring subject (hereinafter referred to as a “monitoring subject detection signal”) is detected in a monitoring area to the management device 200 through the communication device T1 when the monitoring subject is detected in the monitoring area while the shovel 100 is remotely controlled. This enables the management device 200 to identify that the monitoring subject is present in the monitoring area around the shovel 100.

The functions of the object detection part 302 may be switched between ON (enabled) and OFF (disabled) according to a predetermined operation by a user such as an operator of the input device 54. In this case, each of a function of detecting a monitoring subject based on an output of the imaging device 40 or a function of detecting a monitoring subject based on an output of the peripheral object information acquisition device 45 may be a switchable mode between ON (enabled)/OFF (disabled).

The object detection part 302 may detect a monitoring subject in the monitoring area around the shovel 100 based only on the output of either the imaging device 40 or the peripheral object information acquisition device 45. The peripheral object information acquisition device 45 may be omitted when the object detection part 302 detects a monitoring subject in the monitoring area around the shovel 100 based only on the output of the imaging device 40.

The safety check detection part 303 detects the presence or the absence of a safety check around the shovel 100 by an operator in the cabin 10. The operator's safety check around the shovel 100 includes, for example, a blind spot area check (visual check) by the operator. The blind spot area includes at least one of an area at the rear side, an area at the left side, an area at the right side, and the like of the upper turning body 3 as described above. The operator normally operates the shovel 100 with direct visual identification of the front side of the upper turning body 3, including an end attachment such as the bucket 6 in front of the shovel 100 and its periphery ahead of the shovel 100, so that the operator's viewing frequency of the rear, left, and right sides of the upper turning body 3 is relatively low. Further, the operator's safety check around the shovel 100, for example, does not include a condition where the operator views the blind spot area momentarily, but includes a condition where the operator continues to view the blind spot area for a certain period of time (for example, several seconds). Further, the operator's safety check around the shovel 100 may include not only a condition where the operator directly checks (visually recognizes) the blind spot area but may also include a condition where the operator indirectly checks (visually recognizes) the blind spot area through a rearview mirror, a sideview mirror, a peripheral image displayed by the display device 50, or the like.

The safety check detection part 303 detects a presence or an absence of the operator's safety check around the shovel 100 based on, for example, the output of the line-of-sight detection device 56 (an example of an acquisition device). Specifically, the safety check detection part 303 may detect that a safety check around the shovel 100 has been performed by the operator when the operator's line of sight is directly or indirectly viewing a blind spot area of the shovel 100 (i.e., at least one of the left side, the right side, or the rear side of the shovel 100) for a certain period of time or more. The safety check detection part 303 may detect that the safety check around the shovel 100 has been performed by the operator when an operation input (an example of a predetermined input) is received with respect to a predetermined operation target (e.g., an icon), which is displayed on the display device 50 together with the peripheral images through the operation input device (an example of an acquisition device) included in the input device 54. The safety check detection part 303 may, for example, detect that a safety check around the shovel 100 has been performed by an operator when a voice input (for example, “safety check completed” or the like) indicating that the safety check has been performed by the operator (for example, a predetermined input) is received through the voice input device (an example of an acquisition device) included in the input device 54.

The safety check detection part 303 may detect the presence or the absence of the operator's safety check when the shovel 100 is in a predetermined condition that is relatively suitable for the operator to perform the safety check around the shovel 100 (hereinafter referred to as a “safety check suitable condition”). That is, when the shovel 100 is not in the safety check suitable condition, the safety check detection part 303 may not determine that the operator's safety check has been performed and may detect an “absence” of the operator's safety check despite the fact that the operator's safety check has been performed. Thus, the controller 30 may, for example, exclude the operator's inappropriate safety check around the shovel 100 from the safety check certification practices when monitoring the presence or the absence of the operator's safety check around the shovel 100, as described below.

The safety check suitable condition includes, for example, a condition in which all the driven elements of the shovel 100 are stopped. The safety check suitable condition also includes, for example, a neutral condition in which an operation input (e.g., an operation input to the operation device 26 or an operation input of a remote-control operation) to a driven element (actuator) of the shovel 100 is zero. The safety check suitable condition also includes, for example, a condition in which the gate lock lever is lowered and the gate lock function (the disable function of the actuator of the shovel 100) is activated.

The log information described above may include information indicating that a safety check has been performed by an operator of the shovel 100, which is detected by the safety check detection part 303. Thus, a user of the management device 200 can identify the condition of a safety check around the shovel 100 performed by each operator of the shovel 100.

The safety control part 304 performs controls relating to a safety function of the shovel 100. Specifically, the safety control part 304 performs controls relating to the safety function to avoid contact between the shovel 100 and its surrounding objects.

The safety control part 304 activates a predetermined safety function (hereinafter referred to as a “first safety function” for convenience) when the monitoring subject is detected in the monitoring area by the object detection part 302, for example.

The first safety function includes, for example, a function to output an alarm to at least one of the inside or outside of the cabin 10 to notify an operator or the like in the cabin 10, or workers or the like around the shovel 100 that a monitoring subject is being detected (hereinafter referred to as a “notification function”).

The safety control part 304 activates the notification function when the monitoring subject is being detected within a predetermined range (hereinafter referred to as a “notification range”) included in the monitoring area by the object detection part 302. The notification range may be the same as the monitoring area or the notification range may be set such that its outer edge is relatively closer to the shovel 100 than that of the monitoring area. Accordingly, an operator or the like inside the cabin 10 and a worker or the like around the shovel 100 can identify that a monitoring subject is present within the predetermined range around the shovel 100.

The safety control part 304 activates a notification function by sound (i.e., in an auditory manner) for at least one of the inside or the outside of the cabin 10, for example, by controlling the sound output device 52. Thus, the sound output device 52 can provide an auditory notification function under the control of the controller 30. In this case, the safety control part 304 may vary the pitch, sound pressure, and tone of output sound, sounding cycle when sound is sounded periodically, and content of voice information according to various conditions.

The safety control part 304 also activates the notification function to display image information to the inside of the cabin 10, for example, by controlling the display device 50. Specifically, the safety control part 304 may display an image representing that a monitoring subject has been detected on the peripheral image displayed on the display device 50. The safety control part 304 may also highlight the monitoring subject in the peripheral image displayed on the display device 50 or a position in the peripheral image corresponding to the position of the detected monitoring subject viewing from the shovel 100. More specifically, the safety control part 304 may superimpose and display a frame surrounding the monitoring subject reflected on the peripheral image, or may superimpose and display a marker at a position corresponding to the actual position of the detected monitoring subject in the peripheral image. This enables the display device 50 to implement a visual notification function with respect to the operator under the control of the controller 30.

The safety control part 304 may also activate a notification function in a visual manner with respect to workers or a supervisor around the shovel 100, for example, by controlling a front light disposed on or an external display device disposed in a compartment of the upper turning body 3. The safety control part 304 may also activate the notification function with respect to the operator in the cabin 10 in a tactile manner, for example, by controlling a vibration generator that vibrates the operator's seat where the operator is seated. This enables the controller 30 to make the operator, and workers and a supervisor around the shovel 100 aware of the presence of monitoring subjects (e.g., workers and other people) around the shovel 100. Accordingly, the controller 30 may prompt the operator to perform a safety check with respect to an area around the shovel 100, while prompting workers and other people within the monitoring area to evacuate from the monitoring area.

The safety control part 304 may also vary a notification mode (i.e., a method of notification) according to a positional relationship between the monitoring subject detected within the notification range and the shovel 100.

For example, the safety control part 304 may output an alarm with a relatively low level of urgency (hereinafter referred to as a “caution level alarm”) to prompt an operator or the like to caution the monitoring subject when the monitoring subject detected within the notification range by the object detection part 302 is located at a position relatively far from the shovel 100. Hereinafter, a notification range that is relatively far from the shovel 100 among the notification ranges, i.e., a range that corresponds to the caution level alarm, may be referred to as a “caution notification range” for convenience. Meanwhile, the safety control part 304 may output an alarm with a relatively high level of urgency (hereinafter referred to as a “warning level alarm”), which signals that the monitoring subject is approaching the shovel 100 and the danger level is increasing when the monitoring subject detected within the notification range by the object detection part 302 is relatively close to the shovel 100. Hereinafter, a notification range that is relatively close to the shovel 100 in distance among the notification ranges, i.e., a range corresponding to a warning level alarm, may be referred to as a “warning notification range.

In this case, the safety control part 304 may vary the pitch, sound pressure, tone, sounding cycle, content of voice information, and the like of the sound output from the sound output device 52 between the caution level alarm and the warning level alarm. The safety control part 304 may also vary the color, shape, size, presence or absence of blinking, blinking cycle, and the like of an image representing that a monitoring subject is detected on the peripheral image displayed on the display device 50 or of an image (for example, a frame, a marker, or the like) highlighting the monitoring subject or the position of the monitoring subject between the caution level alarm and the warning level alarm. This enables the controller 30 to allow the operator and others to identify the urgency level, or in other words, the proximity level of the monitoring subject with respect to the shovel 100, by the difference in the notification sound (warning sound) output from the sound output device 52 and difference in the notification image displayed on the display device 50.

The first safety function includes, for example, a function to prompt an operator in the cabin 10 to perform a safety check around the shovel 100 (hereinafter referred to as a “safety check function”).

The safety control part 304 operates the safety check function when a monitoring subject is detected within a predetermined range (hereinafter referred to as a “safety check range”) included in the monitoring area by, for example, the object detection part 302. The safety check range may be the same as the monitoring area or the safety check range may be set such that its outer edge is relatively closer to the shovel 100 than that of the monitoring area. This enables the operator or the like inside the cabin 10 to not only be aware of the presence of monitoring subjects within the predetermined area around the shovel 100, but also to actively prompt the operator or the like to perform the safety check around the shovel 100.

The safety control part 304 may activate the safety check function in an auditory manner, for example, by controlling the sound output device 52. Specifically, the safety control part 304 may output voice information from the sound output device 52 to prompt the operator to perform the safety check around the shovel 100.

The safety control part 304 may also activate the safety check function in a visual manner by, for example, controlling the display device 50. Specifically, the safety control part 304 may cause the display device 50 to display text information to prompt the operator to perform a safety check around the shovel 100.

In addition, the safety check function may include safety check functions at multiple stages which differ in the level of strength to prompt the operator to perform the safety check. In this case, the safety control part 304 may vary the pitch, sound pressure, and tone of the sound output from the sound output device 52, the sounding cycle when the sound is sounded periodically, and the content of the voice information for each of the multiple-stage safety check functions. The safety control part 304 may change the color, shape, size, the presence or the absence of blinking, blinking cycle, and the like of the image displayed on the display device 50 for each of the multiple-stage safety check functions.

The safety control part 304 may also teach a safety check suitable condition for the shovel 100 through the display device 50 or the sound output device 52 when the safety check function is activated. This enables the safety control part 304 to prompt the operator to perform the safety check around the shovel 100 in a more appropriate manner. Thus, the safety of the shovel 100 may further be improved.

Further, the safety control part 304 may notify an operator that the shovel 100 is not in the safety check suitable condition when the operator's safety check around the shovel 100 is not detected by the safety check detection part 303 due to the shovel 100 being not in the safety check suitable condition. The safety control part 304 may also notify and prompt the operator to set the shovel 100 in the safety check suitable condition and perform the safety check around the shovel 100 again when the operator's safety check around the shovel 100 is not detected by the safety check detection part 303 due to the shovel 100 being not in the safety check suitable condition. This enables the safety control part 304 to prompt the operator to perform the safety check around the shovel 100 in a more appropriate manner. Thus, the safety of the shovel 100 may further be improved.

Further, the first safety function may include, for example, a function to restrict or prohibit an operation of the shovel 100 in response to the operation of a driven element (e.g., an operation of the operation device 26 or a remote-control operation) (hereinafter referred to as an “operation restriction function”). The operation restriction function includes at least one of an operation deceleration function to make the operation speed of the shovel 100 slower than the normal speed in response to the operation of the hydraulic actuator or an operation deactivation function to deactivate an operation of the shovel 100 and maintain the deactivated condition regardless of the operation of the hydraulic actuator.

The safety control part 304 activates the operation restriction function when the monitoring subject is detected within a predetermined range (hereinafter referred to as an “operation restriction range”) included in the monitoring area by the object detection part 302, for example. The operation restriction range may be the same as the monitoring area or the operation restriction range may be set such that its outer edge is relatively closer to the shovel 100 than that of the monitoring area. The operation restriction range also includes at least one of an operation deceleration range in which the operation speed of the shovel 100 is made slower than its normal speed with respect to the operation of the hydraulic actuator and an operation deactivation range in which the operation of the shovel 100 is stopped to be maintained in the stopped condition regardless of the operation of the actuator. This enables the controller 30 to slow down or stop the operation of the shovel 100 when a monitoring subject is present around the shovel 100. Thus, the controller 30 can prevent the shovel 100 from contacting the monitoring subject around the shovel 100. For example, when the operation restriction range includes both the operation deceleration range and the operation deactivation range, the operation deactivation range is, for example, a range proximate to the shovel 100 among the operation restriction ranges, and the operation deceleration range is a range set outside the operation deactivation range among the operation restriction ranges.

The safety control part 304 may activate the operation restriction function, for example, by controlling a predetermined hydraulic control valve disposed on the pilot line 25 when the operation device 26 is a hydraulic pilot type. Specifically, the safety control part 304 may activate the operation deceleration function by reducing a pilot pressure in the pilot line 25 by using the hydraulic control valve. The safety control part 304 may activate the operation deactivation function by using the hydraulic control valve to cause the pilot line 25 to be in a non-communication condition.

The safety control part 304 may, for example, activate the operation restriction function by adjusting a control signal output from the controller 30 to the hydraulic control valve 31 according to contents of the operation of the operation device 26 (the lever devices) or contents of the remote-control operation when the operation device 26 is an electric type. Specifically, the safety control part 304 may activate the operation deceleration function by outputting a control signal making the operation speed of the hydraulic actuator relatively lower than that of the operation contents to the hydraulic control valve 31. The safety control part 304 may activate the operation deactivation function by preventing the control signal itself from being output to the hydraulic control valve 31.

The safety control part 304 may also activate the operation restriction function, for example, by controlling the hydraulic control valve 33. Specifically, the safety control part 304 may use the hydraulic control valve 33 to activate the operation deceleration function by reducing the pilot pressure in the pilot line 27B on the secondary side of the operation device 26 (lever device). The safety control part 304 may activate the operation deactivation function by using the hydraulic control valve 33 to cause the pilot line 27B to be in the non-communication condition.

The safety control part 304 may also activate the operation restriction function, for example, by controlling, from among the two hydraulic control valves 31 disposed for each driven element (hydraulic actuator), a hydraulic control valve 31 corresponding to an operation of the hydraulic actuator in a direction opposite to the operation direction of the hydraulic actuator. Specifically, the safety control part 304 may activate the operation restriction function by applying pilot pressure from the hydraulic control valve 31 to the second pilot port of the control valve in a manner opposing a pilot pressure acting on the first pilot port of the control valve in response to the operator's operation. Similarly, the safety control part 304 may activate the operation restriction function by applying pilot pressure from the hydraulic control valve 31 to the first pilot port of the control valve in a manner opposing a pilot pressure acting on the second pilot port of the control valve in response to the operator's operation.

The safety control part 304 may activate the operation restriction function (operation deactivation function) by, for example, lowering the output of the engine 11 as a motor or stopping the engine 11.

The safety control part 304 may vary the control mode relating to the first safety function between a case in which a monitoring subject is detected based on the output (a captured image) of the imaging device 40 and a case in which a monitoring subject is detected based on the output of the peripheral object information acquisition device 45.

For example, the safety control part 304 activates only the notification function and the safety check function in the first safety function when a monitoring subject is detected from the output of the imaging device 40 by the object detection part 302. That is, when a monitoring subject is detected from the output of the imaging device 40 by the object detection part 302, the safety control part 304 does not activate the operation restriction function, regardless of the distance or the like between the monitoring subject and the shovel 100. Specifically, when a monitoring subject is detected by the object detection part 302 within a notification range (hereinafter referred to as a “first notification range” for convenience) of the imaging device 40, the safety control part 304 activates the notification function and the safety check function so as not to set an operation restriction range (hereinafter referred to as a “first operation restriction range” for convenience) corresponding to the detection of the monitoring subject from the captured image of the imaging device 40.

Meanwhile, the safety control part 304 activates the safety check function and the operation restriction function when a monitoring subject is detected by the object detection part 302 within an operation restriction range (hereinafter referred to as a “second operation restriction range” for convenience) from the output of the peripheral object information acquisition device 45. The safety control part 304 may activate the notification function when a monitoring subject is detected by the object detection part 302 in a notification range (“second notification range” hereinafter for convenience) from the output of the peripheral object information acquisition device 45. The first notification range and the second notification range may be the same or different.

For example, when the operation restriction function is activated based on the detection result although the detection result indicates relatively low detection accuracy with respect to the monitoring subject, it is more likely to cause discomfort to the operator or to reduce the work efficiency of the shovel 100 compared to the case when the notification function is activated.

By contrast, in this example, the controller 30 allows activation of the operation restriction function when a monitoring subject is detected only from the output of the peripheral object information acquisition device 45, among those of the imaging device 40 and the peripheral object information acquisition device 45. This is because the detection accuracy tends to be relatively higher when the monitoring subject is detected from the received light information of the peripheral object information acquisition device 45 than when the monitoring subject is detected by image recognition with respect to the captured image of the imaging device 40. This enables the controller 30 to improve the safety of the shovel 100 while preventing discomfort given to the operator and a decrease in the work efficiency of the shovel 100.

The log information described above may include information indicating that the first safety function has been activated. This enables a user of the management device 200 to check an activation status of the first safety function for each shovel 100.

Further, the safety control part 304 activates a predetermined safety function (hereinafter referred to as a “second safety function” for convenience) when, for example, a safety check around the shovel 100 is not performed by an operator in the cabin 10 for more than a predetermined time. In other words, the safety control part 304 may activate the second safety function when the operator in the cabin 10 relatively infrequently performs a safety check around the shovel 100.

The second safety function includes, for example, a safety check function to prompt an operator in the cabin 10 to perform a safety check around the shovel 100.

The safety control part 304 may operate the safety check function in the same manner as in the case of the first safety function.

The second safety function may also include, for example, an operation restriction function to restrict or prohibit the operation of the shovel 100 with respect to an operation of a driven element (e.g., a hydraulic actuator), specifically an operation of the operation device 26. As in the first safety function, the operation restriction function includes at least one of an operation deceleration function and an operation deactivation function.

The safety control part 304 may operate the operation restriction function in the same manner as in the case of the first safety function.

The log information described above may include information indicating that the second safety function has been activated. Thus, a user of the management device 200 can check the activation status of the second safety function for each shovel 100.

<Configuration of Management Device>

The management device 200 includes a control device 210, a communication device 220, an output device 230, an input device 240, and a line-of-sight detection device 250.

The control device 210 performs various controls relating to the management device 200. The control device 210 may implement its functions in any hardware or any combination of hardware and software. For example, the control device 210 is configured mainly by a computer including a memory device such as a CPU, a RAM, a non-volatile auxiliary storage device such as a ROM, and an external I/O interface device. The control device 210 may also include high speed computing circuitry such as GPU, ASIC, FPGA, or the like, for example, in conjunction with the CPU. The control device 210 includes a remote control support part 2101, a safety check detection part 2102, and a safety control part 2103 as functional parts to be implemented, for example, by executing a program installed in an auxiliary storage device on the CPU.

The communication device 220 communicates with an external device (for example, a shovel 100) through the communication network NW. The communication device 220 is, for example, a modem or an ONU (Optical Network Unit). The communication device 220 may be, for example, a mobile communication module connected to a mobile communication network having a base station as its terminal. The communication device T1 may be, for example, a satellite communication module connected to a satellite communication network using a communication satellite. The communication device T1 may be, for example, a WiFi communication module or a Bluetooth communication module for performing near field communication.

The output device 230 outputs various information to a user of the management device 200 under the control of the control device 210. Users of the management device 200 include, for example, a manager of the management device 200, a worker, an operator who remotely controls the shovel 100, an observer who monitors an operation of the shovel 100 operating with an automatic operation function, and the like.

The output device 230 includes, for example, a display device configured to visually output various information relating to the management device 200 (e.g., various information received from the shovel 100) to a user of the management device 200. The display device may be, for example, a liquid crystal display and an organic EL display.

The output device 230 also includes, for example, a sound output device configured to audibly output various information relating to the management device 200 to a user of the management device 200. The sound output device may be, for example, a buzzer or a speaker.

The output device 230 also includes a display device 230A used by, for example, an operator who remotely controls the shovel 100 or an observer who remotely monitors the shovel 100 operating with the automatic operation function.

The display device 230A displays various information images to support remote controlling and remote monitoring of the shovel 100 under the control of the control device 210. The display device 230A, for example, displays peripheral images depicting views of the surroundings of the shovel 100. The peripheral images include image information representing a view of the front side of the shovel 100 as well as image information representing at least one view of the left side, the right side, and the rear side of the shovel 100, as in the case of the display device 50 of the shovel 100.

The control device 210 may display log information received from the shovel 100 on the display device 230A, for example, through the communication device 220. Thus, a user of the management device 200 can check various conditions in the shovel 100.

Specifically, the control device 210 may display, on the display device 230A, information relating to conditions for the operator's safety check around the shovel 100 (e.g., the frequency of safety checks) on a per set of the multiple shovels 100 basis. Accordingly, a user of the management device 200 is able to determine whether or not an operator has appropriately performed the safety check around the shovel 100 on a per set of the multiple shovels 100 basis. The control device 210 may also extract or highlight a shovel 100 with a relatively low frequency of the operator's safety checks around the shovel 100, from among the multiple shovels 100. Accordingly, a user of the management device 200 can use such information to alert an operator of the shovel 100 who is likely to neglect to perform the safety check around the shovel 100.

The input device 240 receives an operation input from the user of the management device 200 and outputs the received input content to the control device 210.

The input device 240 includes, for example, an operation input device that receives the operation input by the user of the management device 200. Examples of the operation input device include, for example, a keyboard, a mouse, a touch panel, and the like.

The input device 240 may include, for example, a voice input device configured to receive a voice input by a user of the management device 200 or a gesture input device configured to receive a gesture input by the user of the management device 200. The voice input device includes, for example, a microphone. Also, the gesture input device includes, for example, an imaging device configured to image a gesture performed by the user of the management device 200.

The input device 240 also includes, for example, an operation device 240A used by an operator to remotely control the shovel 100.

The operation device 240A is used to remotely control the multiple driven elements or hydraulic actuators of the shovel 100. The operation device 240A may be configured in the same manner as the operation device 26 of the shovel 100, i.e., the operation device 240A may be configured to mainly include the lever devices. The operation device 240A (lever devices) outputs an electrical signal (hereinafter referred to as a “remote-control signal”) corresponding to operation contents, i.e., remote-control contents, and the remote-control signal is incorporated into the control device 210.

The input device 240 may also include an input device configured to cause emergency stop of the shovel 100 operating with the automatic operation function or an input device configured to cancel the emergency stop condition. This enables an observer to use the input device 240 to stop the shovel 100 in an emergency, for example, when contact between the shovel 100 and surrounding objects is likely to occur. The observer may then use the input device 240 to restart the operation of the shovel 100 operating with an automatic operation function when the observer determines that the safety has been secured.

A line-of-sight detection device 250 is disposed near the seat of an operator who performs the remote-control operation on the shovel 100, i.e., an operator who performs the operation of the operation device 240A, or an observer who monitors the shovel 100 operating with an automatic operation function to detect a line of sight of the operator or the observer. Detection information corresponding to the line of sight of the remote operator as detected by the line-of-sight detection device 250 is incorporated into the control device 210.

The remote control support part 2101 supports the remote-control operation of the shovel 100 by an operator of the management device 200.

The remote control support part 2101, for example, displays on the display device 230A peripheral images representing views of the surroundings of the shovel 100 on the basis of the images captured by the imaging device 40 (camera 40X) received from the shovel 100 via the communication device 220. Thus, the operator of the management device 200 can remotely control the shovel 100 while checking the views of the surroundings of the shovel 100 displayed on the display device 230A.

When a peripheral image displayed on the display device 230A is a processed image, the processed image generated by the shovel 100 may be transmitted from the shovel 100 to the management device 200 in place of the image captured by the imaging device 40.

The remote control support part 2101 transmits, for example, a remote-control signal representing remote-control contents input from the operation device 240A to the shovel 100 through the communication device 220. This enables the operation contents of the operation device 240A to be reflected in the operation of the shovel 100, thereby implementing remote-control operation of the shovel 100.

The safety check detection part 2102 detects the presence or the absence of a safety check around the shovel 100 by an operator or an observer of the management device 200, i.e., an operator who remotely controls the shovel 100 or an observer who remotely monitors the shovel 100 operating with an automatic operation function. The safety check around the shovel 100 by the operator of the management device 200 includes, for example, a condition in which the operator or the observer checks (visually) the blind spot area (e.g., at least one of the left side, the right side, and the rear side of the upper turning body 3) contained in the peripheral images displayed on the display device 50.

The safety check detection part 2102 detects the presence or the absence of a safety check around the shovel 100 by an operator or an observer, based on the output of the line-of-sight detection device 250, for example, as in the case of the safety check detection part 303. The safety check detection part 2102 may, for example, detect that a safety check around the shovel 100 has been performed by the operator or the observer when a predetermined operation target displayed with the peripheral images on the display device 230A is operated through the input device 240 as in the case of the safety check detection part 303. The safety check detection part 2102 may, for example, detect that a safety check around the shovel 100 has been performed by the operator or the observer when a voice input indicating that a safety check has been performed by the operator or the observer is received through the voice input device included in the input device 240 as in the case of the safety check detection part 303.

The safety check detection part 2102 may detect the presence or the absence of the operator's safety check in a situation where the shovel 100 is in a condition suitable for a safety check, for example, as in the case of the safety check detection part 303. That is, when the shovel 100 is not in the condition suitable for the safety check, the safety check detection part 2102 may not determine that the safety check has been performed by the operator even when the safety check has been performed by the operator, and may determine that “no” safety check by the operator (the absence of the safety check by the operator) has been detected.

The safety control part 2103 performs controls relating to a safety function of the shovel 100. Specifically, the safety control part 2103 performs controls relating to the safety function to avoid contact between the shovel 100 and its surrounding objects as in the case of the safety control part 304.

For example, when a monitoring subject detection signal is received from the shovel 100 via the communication device 220, that is, when a monitoring subject has been detected in the monitoring area by the object detection part 302, the safety control part 2103 activates a predetermined safety function (hereinafter referred to as a “third safety function” for convenience).

The third safety function, for example, as in the case of the first safety function, includes a notification function that outputs an alarm or the like to notify an operator or an observer of the management device 200 that a monitoring subject is being detected.

The safety control part 2103, for example activates the notification function when the monitoring subject is detected by the object detection part 302 within a notification range included in the monitoring area, as in the case of the safety control part 304.

The safety control part 2103, for example, controls the sound output device included in the output device 230 to activate a notification function using sound, as in the case of the safety control part 304. This enables the output device 230 to provide an auditory notification function under the control of the control device 210.

Also, the safety control part 2103, for example, as in the case of the safety control part 304, controls a display device included in the output device 230, to activate a notification function by displaying image information. This enables the output device 230 to provide a visual notification function to an operator or an observer under the control of the control device 210.

The third safety function includes a safety check function configured to prompt an operator of the management device 200, i.e., an operator who remotely controls the shovel 100 or an observer who remotely monitors the shovel 100 operating with the automatic operation function, to perform a safety check around the shovel 100.

The safety control part 2103, for example, as in the case of the safety control part 304, activates the safety check function when the monitoring subject is detected by the object detection part 302 within a safety check range included in the monitoring area.

The safety control part 2103 may, for example, activate the safety check function in an auditory manner by controlling the sound output device included in the output device 230, as in the case of the safety control part 304. Specifically, the safety control part 2103 may cause the output device 230 (a sound output device) to output voice information that prompts an operator to perform a safety check around the shovel 100.

The safety control part 2103 may activate the safety check function in a visual manner by controlling a display device included in the output device 230, for example, as in the case of the safety control part 304. Specifically, the safety control part 2103 may cause the output device 230 (a display device) to display character information that prompts an operator to perform a safety check around the shovel 100.

The safety control part 2103, for example, activates a predetermined safety function (hereinafter referred to as a “fourth safety function” for convenience) when the safety check around the shovel 100 is not performed for more than a predetermined time by an operator of the management device 200, that is, an operator who remotely controls the shovel 100 or an observer who remotely monitors the shovel 100 operating with the automatic operation function. In other words, the safety control part 2103 may activate the fourth safety function when the frequency of safety checks around the shovel 100 by the operator of the management device 200 is relatively low.

The fourth safety function includes, for example, a safety check function that prompts an operator or an observer of the management device 200 to perform a safety check around the shovel 100.

The safety control part 2103 may, for example, activate a safety check function in the same manner as in the case of the third safety function.

The fourth safety function may also include, for example, an operation limiting function that limits or prohibits the operation of the excavator 100 for remote operation of the driven element (hydraulic actuator).

The fourth safety function may also include, for example, an operation restriction function for restricting or prohibiting an operation of the shovel 100 for remotely controlling a driven element (hydraulic actuator). The operation restriction function includes at least one of an operation deceleration function and an operation deactivation function, as in the cases of the first and second safety functions.

The safety control part 2103, for example, as in the case of the safety control part 304, may activate the operation restriction function when the safety check around the shovel 100 has not been performed for more than the predetermined time by an operator who remotely controls the shovel 100 or by an observer who remotely monitors the shovel 100 operating with the automatic operation function. Specifically, the safety control part 2103 may transmit a signal requesting an operation of the operation restriction function (hereinafter referred to as an “operation restriction request signal”) to the shovel 100 through the communication device 220. Accordingly, the controller 30 can implement the operation restriction function in response to the operation restriction request signal received by the communication device T1 from the management device 200.

[Specific Examples of Control Process by Controller of Shovel]

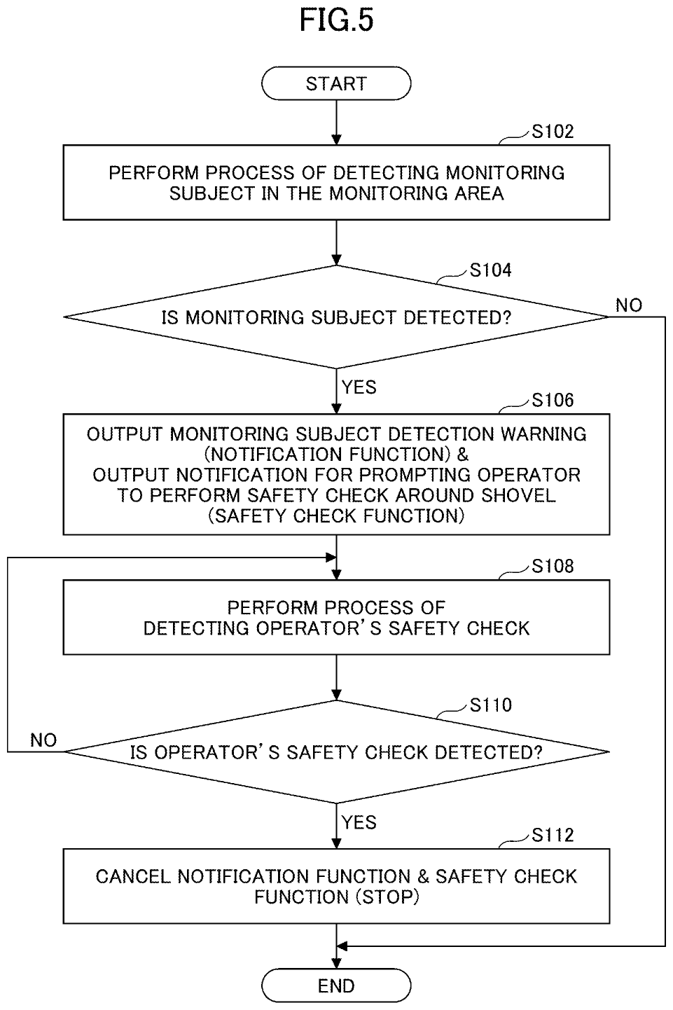

Next, specific examples of a control process relating to the safety function by the controller 30 of the shovel 100 will be described with reference to FIGS. 5 to 7.

<First Example of Control Process for Safety Function>

FIG. 5 is a flowchart schematically illustrating a first example of a control process relating to the safety functions by the controller 30. Specifically, FIG. 5 is a flowchart schematically illustrating a specific control process for the first safety function by the controller 30. The flowchart is executed repeatedly at intervals of a predetermined time, e.g., from the start of the shovel 100 (e.g., ON of the key switch) to the stop of the shovel 100 (e.g., OFF of the key switch).

As illustrated in FIG. 5, in step S102, the object detection part 302 performs a process of detecting a monitoring subject in the monitoring area. When the process in step S102 is completed, the controller 30 proceeds to step S104.

In step S104, the object detection part 302 determines whether or not a monitoring subject is detected by the detection process in step S102. When the monitoring subject is detected in the monitoring area, the object detection part 302 proceeds to step S106. When the monitoring subject is not detected, the object detection part 302 ends the process of the present flowchart.

In step S106, the safety control part 304 activates the first safety function. Specifically, the safety control part 304 activates a notification function to notify at least one of the inside and the outside of the cabin 10 that a monitoring subject has been detected and a safety check function to prompt an operator in the cabin 10 to perform a safety check around the shovel 100. When the process in step S106 is completed, the controller 30 proceeds to step S108.

In step S108, the safety check detection part 303 performs a process of detecting the presence or the absence of a safety check around the shovel 100 performed by an operator in the cabin 10. When the process in step S110 is completed, the controller 30 proceeds to step S110.

In step S110, the safety check detection part 303 determines whether or not a safety check around the shovel 100 by an operator in the cabin 10 is detected through the detection process in step S108. When a safety check around the shovel 100 performed by an operator in the cabin 10 is detected, the safety check detection part 303 proceeds to step S112, and otherwise returns to step S108 to repeat the processes of steps S108 and S110.

In step S112, the safety control part 304 cancels the notification function and a safety check function that are still in operation by the process in step S106 to stop the notification function and a safety check function. When the process in step S112 is completed, the controller 30 completes the process of the present flowchart.

As described above, in the present example, the display device 50 or the sound output device 52 prompts, under the control of the controller 30, an operator in the cabin 10 to perform a safety check with respect to an area around the shovel 100 when a monitoring subject is detected in the monitoring area.

For example, even when the operator is notified that a monitoring subject has been detected, there may be a case where the operator may not notice such detection, or even when the operator has noticed the detection, the operator may neglect to perform a safety check with respect to an area around the shovel 100.

By contrast, in the present example, the shovel 100 can actively prompt an operator in the cabin 10 to perform a safety check around the shovel 100 (itself). This may increase the possibility that an operator in the cabin 10 will perform a safety check around the shovel 100 when a monitoring subject is detected around the shovel 100. Thus, it is possible to prevent a situation in which an object around the shovel 100 contacts the shovel 100, thereby improving the safety of the shovel 100.

<Second Example of Control Process for Safety Function>

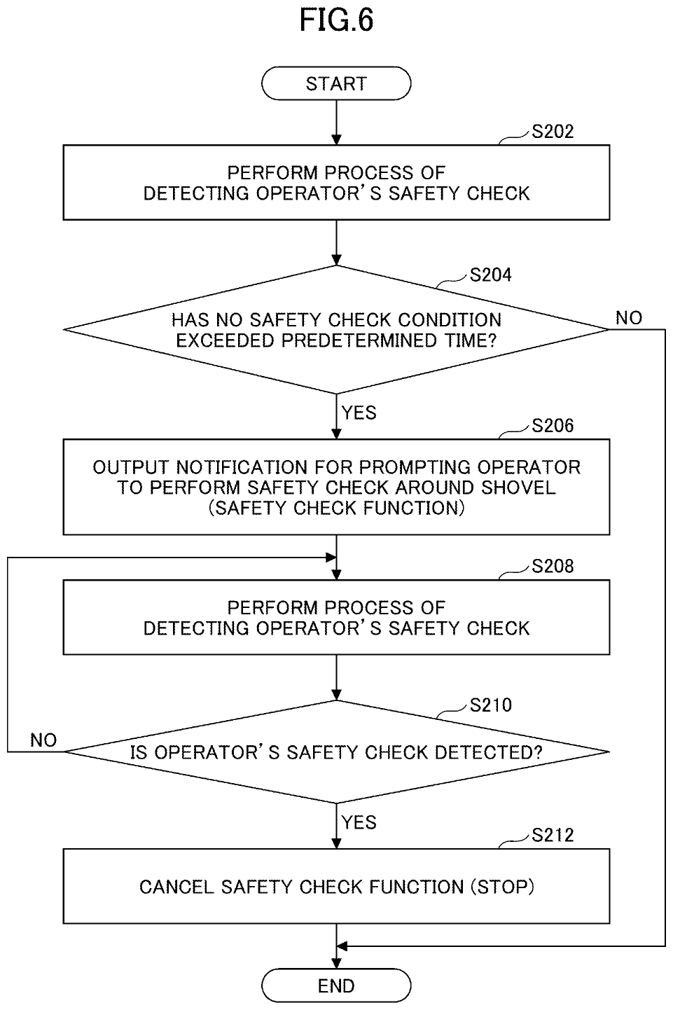

FIG. 6 is a flowchart schematically illustrating a second example of a control process relating to a safety function by the controller 30. Specifically, FIG. 6 is a flowchart schematically illustrating a specific example (one example) of a control process relating to the second safety function by the controller 30. The flowchart is executed repeatedly at intervals of a predetermined time, in a period e.g., from the start (e.g., ON of the key switch) to the stop (e.g., OFF of the key switch) of the shovel 100. The flowchart may be executed repeatedly at the intervals of the predetermined time only when the monitoring subject is not detected by the object detection part 302, for example.

As illustrated in FIG. 6, in step S202, the safety check detection part 303 performs a process of detecting the presence or the absence of a safety check around the shovel 100 by an operator in the cabin 10. When the process in step S202 is completed, the controller 30 proceeds to step S204.

In step S204, the safety check detection part 303 determines whether or not a condition in which no safety check around the shovel 100 has been performed by the operator in the cabin 10 exceeds the predetermined time. When the operator in the cabin 10 has not performed a safety check around the shovel 100 for more than the predetermined time, the safety check detection part 303 proceeds to step S206, and otherwise ends the process of the present flowchart.

In step S206, the safety control part 304 activates a safety check function to prompt an operator in the cabin 10 to perform a safety check around the shovel 100. When the process in step S206 is completed, the controller 30 proceeds to step S208.

Since the processes in steps S208 and S210 are the same as those in steps S108 and S110 in FIG. 5, the description thereof will not be repeated.

In step S212, the safety control part 304 cancels a safety check function that is still in operation by the process in step S206 to stop a safety check function. When the process in step S212 is completed, the controller 30 completes the process of the present flowchart.

Thus, in the present example, the controller 30 activates a safety check function to prompt an operator in the cabin 10 to perform a safety check around the shovel 100 when the operator in the cabin 10 has not performed a safety check around the shovel 100 for more than the predetermined time.

For example, there may be a case where the object detection part 302 is unable to detect a monitoring subject despite the presence of the monitoring subject in the monitoring area. In this case, the object detection part 302 fails to activate the safety function (e.g., the first safety function) based on the detection of the monitoring subject, and the operator may not notice the monitoring subject, which may result in contact between the shovel 100 and the monitoring subject.

By contrast, in the present example, the display device 50 or the sound output device 52 may prompt an operator in the cabin 10 to perform a safety check around the shovel 100 when the operator in the cabin 10 has not performed the safety check around the shovel 100 for more than a predetermined time under the control of the controller 30. This enables the shovel 100 to prompt an operator in the cabin 10 to perform the safety check with respect to an area around the shovel 100 at intervals of at least a maximum of a predetermined time (at intervals of the predetermined time or less). Thus, even when the object detection part 302 is unable to detect a monitoring subject, it is possible for the shovel 100 to increase the possibility that an operator in the cabin 10 recognizes the presence of a monitoring subject. Accordingly, the shovel 100 can prevent a situation in which an object around the shovel 100 contacts the shovel 100 (itself), thereby increasing the safety of the shovel 100 (itself).

The above predetermined time corresponding to a time interval for prompting an operator to perform a safety check around the shovel 100 may also vary according to work contents of the shovel 100. That is, the predetermined time may be set to differ according to the work contents of the shovel 100. For example, depending on the work contents of the shovel 100, the presence or the number of objects (e.g., workers) acting as monitoring subjects around the shovel 100 may differ, and criteria for the length of each interval used to perform a safety check around the shovel 100 may vary. The work contents of the shovel 100 include, for example, excavation, rolling, loading of earth and sand into trucks, crane operations, and the like. The work contents of the shovel 100 may be determined automatically based, for example, on the image captured by the imaging device 40 or the operation contents of the multiple driven elements (hydraulic actuators), or may be manually set by a predetermined input from an operator through the input device 54 or the input device 240. This enables the shovel 100 to achieve both operational efficiency and safety.

The predetermined time may vary according to the operation contents (operation conditions) of the shovel 100. That is, the predetermined time may be set to differ according to the operation contents (the operation conditions) of the shovel 100. For example, in a situation where only the attachment of the shovel 100 is operated, the operator captures a moving range of the attachment within the operator's forward field of view. Thus, the above predetermined time may be set to be relatively longer (e.g., several tens of seconds). When the operator performs the safety check around the shovel 100 before performing a rearward operation to move the lower traveling body 1 rearward with reference to the front of the upper turning body 3, a person who is not present around the shovel 100 may enter the traveling direction of the lower traveling body within 10 seconds. Thus, in the situation where the operator performs an operation to move the lower traveling body 1 rearward, the above predetermined time may be set to be relatively short (for example, less than 10 seconds). Similarly, when the operator performs an operation to turn the upper turning body 3, the predetermined time may be set to be relatively short. Also, for example, in a neutral condition in which the driven elements of the shovel 100 are not operated, the predetermined time may be set to be relatively short. This is because the operator may neglect to perform a safety check when the operator starts the operation from the neutral condition.

<Third Example of Control Process for Safety Function>

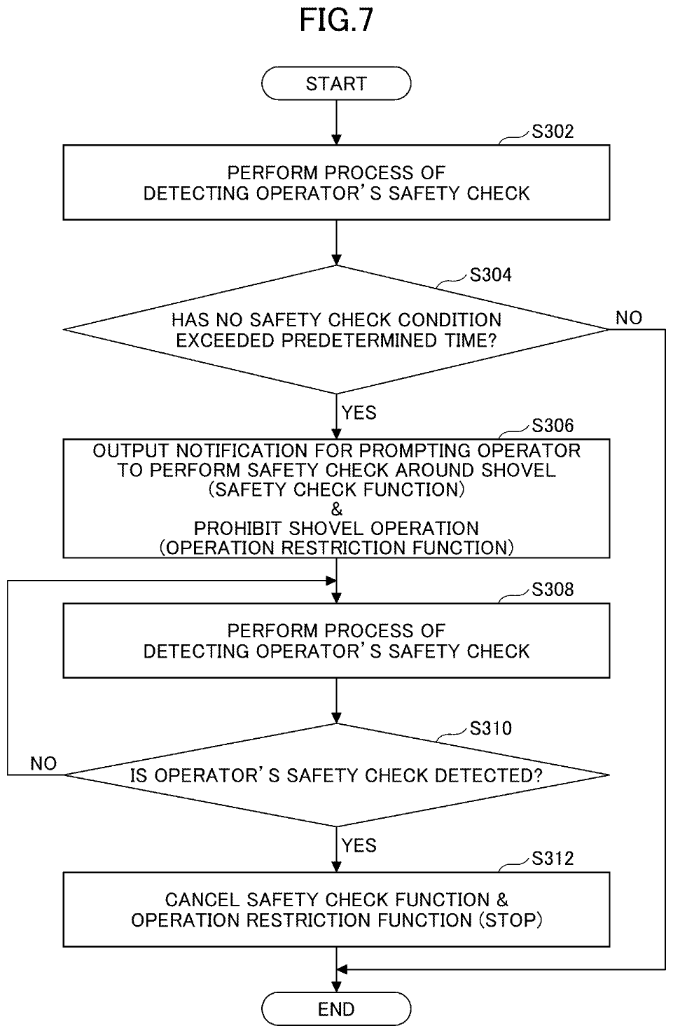

FIG. 7 is a flowchart schematically illustrating a third example of a control process relating to a safety function performed by the controller 30. Specifically, FIG. 7 is a flowchart illustrating a specific example (another example) of a control process relating to a second safety function performed by the controller 30.

As illustrated in FIG. 7, since the processes in step S302 and step S304 are the same as those in step S202 and step S204 in FIG. 6, the description thereof will not be repeated.

In step S306, the safety control part 304 activates a safety check function to prompt an operator in the cabin 10 to perform a safety check around the shovel 100 and an operation restriction function to restrict or prohibit the operation of the shovel 100 with respect to the operator's operation. When the process in step S306 is completed, the controller 30 proceeds to step S308.

Since the processes in the steps S308 and S310 are the same as those in the S208 and S210 illustrated in FIG. 6, the description thereof will not be repeated.

In step S312, the safety control part 304 cancels a safety check function and the operation restriction function that are still in operation to stop a safety check function and the operation restriction function by performing a process in step S306. When the process in step S312 is completed, the controller 30 completes the process of the present flowchart of FIG. 7.

Thus, in the present embodiment, the controller 30 activates the operation restriction function that restricts or prevents the operation of the shovel 100 with respect to the operation of the operator in the cabin 10 when the operator in the cabin 10 has not performed a safety check around the shovel 100 for more than the predetermined time.

This enables the operator in the cabin 10 to recognize that the operation of the shovel 100 is restricted and the operation is unable to be continued unless a safety check around the shovel 100 is performed. Thus, the shovel 100 may prompt an operator in the cabin 10 to perform a safety check around the shovel 100 at intervals of the predetermined time or less. Accordingly, the shovel 100 prevents a situation where an object in an area around the shovel 100 (itself) contacts the shovel 100 (itself), thereby increasing the safety of the shovel 100 (itself).

In the present embodiment, the display device 50 and the sound output device 52 continue the operation restriction function of the shovel 100 to restrict or prohibit the operation until the operator performs a safety check around the shovel 100 under the control of the controller 30.

This enables the shovel 100 to oblige the operator in the cabin 10 to substantially perform the safety check with respect to the surroundings of the shovel 100. Therefore, the shovel 100 can further prevent a situation in which an object around the shovel 100 (itself) contacts the shovel 100 (itself), thereby further increasing the safety of the shovel 100 (itself).

<Other Examples of Control Processes for Safety Functions>

The first example (FIG. 5) to the third example (FIG. 7) of the control processes for the above-described safety functions (the first safety function and the second safety function) may be modified or altered, as appropriate.

For example, in the first example described above, the notification function and the safety check function may be stopped for a certain period of time after starting the operation of the notification function and the safety check function, even when the safety check around the shovel 100 has not been performed by the operator. Thus, for example, it is possible to prevent a situation in which the operator is accustomed to a condition in which the operations of the notification function and the safety check function continue and the effects thereof are diminished.

In this case, after step S108 in FIG. 5, the controller 30 may perform a process of determining whether or not a certain period of time has elapsed from the start of the operations of the notification function and the safety check function (hereinafter referred to as a “first additional process”). In the first additional process, when a certain period of time has elapsed from the start of the operations of the notification function and the safety check function, the controller 30 may proceed to step S112, and when the certain period of time has not elapsed, the controller 30 may proceed to step S110.

For example, in the second example described above, the safety check function may be temporarily stopped even when the safety check around the shovel 100 is not performed by the operator when a certain period of time shorter than the predetermined time elapses after the safety check function starts operating. Thus, for example, it is possible to prevent a situation in which the operator is accustomed to a situation in which a safety check function continues operating and the effect thereof is diminished.

In this case, after step S208 in FIG. 6, the controller 30 may perform a process of determining whether or not the certain period of time has elapsed from the start of the operation of the safety check function (hereinafter referred to as the “second additional process”). In the second additional process, when the certain period of time has elapsed from the start of the operation of the safety check function, the controller 30 may proceed to step S212, and when the certain period of time has not elapsed, the controller 30 may proceed to step S210.

For example, in the first example described above, the controller 30 may activate a safety check function that warns for (more strongly prompts) an operator to perform a safety check around the shovel 100 when, after detection of the monitoring subject, the operator has not performed the safety check around the shovel 100 for a predetermined period of time or more. This enables the controller 30 to strongly prompt the operator to perform the safety check around the shovel 100 in a condition where the operator fails to perform the safety check around the shovel 100 even when the controller 30 has started activating the safety check function. In addition, the controller 30 may increase the strength level of prompting the operator to perform the safety check around the shovel 100 in three or more steps every time the predetermined period of time in which the operator has not performed the safety check around the shovel 100 has elapsed.

In this case, for example, in step S106, the controller 30 activates the first safety check function with a relatively low strength level of prompting the operator to perform the safety check around the shovel 100. After its completion, the controller 30 performs a process of determining whether or not a condition in which the safety check around the shovel 100 has not been performed by the operator has continued for a predetermined period of time or more (hereinafter referred to as a “third additional process”). When the condition in which the safety check around the shovel 100 has not been performed by the operator has continued for the predetermined period of time or more, the controller 30 performs a process of activating the second safety check function with a relatively high strength level of prompting the operator to perform the safety check around the shovel 100 (hereinafter referred to as the “fourth additional process”) instead of the first safety check function, and then proceeds to step S108. Meanwhile, the controller 30 otherwise proceeds directly to step S108. In step S110, when the controller 30 determines the absence of the safety check by the operator, the controller 30 returns to the third additional process and repeats the sequence of the third additional process, the fourth additional process, the steps S108 and S110 until the safety check is performed.

For example, in the second example described above, the controller 30 may activate a safety check function (which more strongly prompts) an operator to perform a safety check around the shovel 100 when a situation in which the operator does not perform a safety check around the shovel 100 continues for a predetermined period of time or more. The predetermined period of time is be set to be a period longer than a predetermined time. This enables the controller 30 to strongly prompt the operator to perform a safety check around the shovel 100 in a situation where the operator does not perform a safety check around the shovel 100 even when a safety check function is activated. In addition, the controller 30 may also increase the strength level of prompting the operator to perform a safety check around the shovel 100 in three or more steps every time the predetermined period of time has elapsed in which the operator does not perform a safety check around the shovel 100.

In this case, for example, in step S206, the controller 30 activates the first safety check function with a relatively low strength level of prompting an operator to perform the safety check around the shovel 100. After its completion, the controller 30 performs a process of determining whether a condition in which a safety check around the shovel 100 is not performed by the operator is continued for a predetermined period of time or more (hereinafter referred to as “fifth additional process”). When the condition in which a safety check around the shovel 100 is not performed by the operator continues for the predetermined period of time or more, the controller 30 performs a process of activating the second safety check function with a relatively high strength level of prompting an operator to perform a safety check around the shovel 100 (hereinafter referred to as “the sixth additional process”) instead of the first safety check function, and proceeds to step S208. Meanwhile, the controller 30 otherwise proceeds to step S208. In step S210, when the controller 30 determines the absence of a safety check around the shovel 100, the controller 30 returns to the fifth additional process and repeats the sequence of the fifth additional process, the sixth additional process, and the steps S208 and S210 until a safety check is performed.

For example, in step S106 of the flowchart illustrated in FIG. 5 (first example), as in the case of step S306 of the flowchart illustrated in FIG. 7 (third example), the safety control part 304 may activate the operation restriction function in addition to the notification function and the safety check function. This enables the shovel 100 to prompt an operator of the shovel 100 to perform a safety check around the shovel 100, as in the third example, when a monitoring subject is detected in the monitoring area around the shovel 100. Accordingly, the shovel 100 is capable of preventing a situation in which an object around the shovel 100 (itself) contacts the shovel 100 (itself), thereby increasing the safety of the shovel 100. In this case, in step S112 of the flowchart illustrated in FIG. 5, as in step S312 of the flowchart illustrated in FIG. 7 (third example), the safety control part 304 may cancel the operation restriction function in addition to the notification function and the safety check function. This enables the shovel 100 to continue the operation restriction function until the operator in the cabin 10 performs a safety check around the shovel 100. Thus, as in the third example, the operator of the shovel 100 can be substantially required to perform a safety check around the shovel 100 when a monitoring subject is detected around the shovel 100. Accordingly, the shovel 100 is further capable of preventing a situation in which an object around the shovel 100 (itself) contacts the shovel 100 (itself), thereby further increasing the safety of the shovel 100 (itself).

For example, when the operation of the operation restriction function is added to the first example described above, the controller 30 may activate the operation restriction function when a situation where the operator does not perform the safety check after detection of the monitoring subject continues for a predetermined period of time or more. This enables the controller 30 to allow the operator to continue the operation of the shovel 100 to some extent while prompting the operator to perform a safety check around the shovel 100. Accordingly, the controller 30 can achieve both securing the safety of the shovel 100 or the work site of the shovel 100 and preventing a deterioration in the work efficiency of the shovel 100.

In this case, for example, after step S106 in FIG. 5, the controller 30 performs a process of determining whether or not a situation in which a safety check around the shovel 100 is not performed by the operator continues for a predetermined period of time or more (hereinafter referred to as “seventh additional process”). The controller 30 performs a process of activating the operation restriction function (hereinafter referred to as “the tenth additional process”) when the operator has not performed a safety check around the shovel 100 for the predetermined period of time or more, and proceeds to step S308. Meanwhile, the controller 30 otherwise proceeds to step S308. When the controller 30 determines in step S310 that there is “no” safety check around the shovel 100, the controller 30 returns to the ninth additional process and repeats the sequence of the ninth additional process, the tenth additional process, and the steps S308 and S310 until a safety check is performed.

For example, in the above-described third example, the controller 30 may activate the operation restriction function when a situation in which an operator does not perform a safety check at intervals of a predetermined time or less continues for a predetermined period of time. The predetermined period of time is set for a period longer than the predetermined time. This enables the controller 30 to prompt the operator to perform a safety check around the shovel 100 while allowing the continuous operation of the shovel 100 to some extent. Accordingly, the controller 30 can achieve both securing the safety of the shovel 100 or the work site of the shovel 100 and preventing a deterioration in the work efficiency of the shovel 100.

In this case, for example, in step S306, only a safety check function is activated, and after its completion, the controller 30 performs a process of determining whether a situation where the operator has not performed a safety check around the shovel 100 continues for the predetermined period of time or more (hereinafter referred to as “ninth additional process”). The controller 30 performs a process of activating the operation restriction function (hereinafter referred to as “tenth additional process”) when the operator has not performed a safety check around the shovel 100 for the predetermined period of time or more and proceeds to step S308. Meanwhile, the controller 30 otherwise proceeds to step S308. When the controller 30 determines in step S310 that the absence of a safety check around the shovel 100 has been detected, the controller 30 returns to the ninth additional process and repeats the ninth additional process, the tenth additional process, and the sequence of the processes in steps S308 and S310 until a safety check is performed.

[Examples of control process by control device of management device] Next, a control process by the control device 210 of the management device 200 will be described in detail with reference to FIGS. 5 to 7.

<First Example of Control Process for Safety Function>

The flowchart in FIG. 5 can be incorporated into the control process for the third safety function by the control device 210. In this case, step S102 is replaced by a process in which the control device 210 checks the received data from the shovel 100. Step S104 is replaced by a process of determining whether or not the control device 210 detects a monitoring subject detection signal from the shovel 100 through the communication device 220.

Accordingly, in the present embodiment, the management device 200 may actively prompt an operator who remotely controls the shovel 100 or an observer who remotely monitors the shovel 100 operating with the automatic operation function to perform a safety check around the shovel 100, that is, to check peripheral images displayed by the display device 230A. This enables increasing the possibility that an operator who remotely controls the shovel 100 or an observer who remotely monitors the shovel 100 operating with an automatic operation function will perform the safety check around the shovel 100 when a monitoring subject present around the shovel 100 is detected. Accordingly, it is possible to prevent contact between the shovel 100 and the monitoring subject around the shovel 100 from occurring, thereby improving the safety of the shovel 100.

<Second Example of Control Process for Safety Function>

The flowchart in FIG. 6 can be incorporated into the control process for the fourth safety function by the control device 210.

Accordingly, in the present example, the output device 230 may, under the control of the control device 210, prompt an operator or an observer to perform a safety check around the shovel 100, i.e., to check the peripheral images displayed by the display device 230A, when the safety check is not performed by an operator who remotely controls the shovel 100 or by an observer who remotely monitors the shovel 100 operating with the automatic operation function for more than a predetermined time. This enables the shovel 100 to prompt an operator or an observer of the management device 200 to perform a safety check around the shovel 100 at intervals of the predetermined time or less. Thus, even when the object detection part 302 is unable to detect a monitoring subject, the management device 200 can increase the possibility that an operator who remotely controls the shovel 100 or an observer who remotely monitors the shovel 100 operating with the automatic operation function recognizes the presence of the monitoring subject. Accordingly, the management device 200 can prevent a situation in which a monitoring subject around the shovel 100 contacts the shovel 100, thereby increasing the safety of the shovel 100.

<Third Example of Control Process for Safety Function>

The flowchart in FIG. 7 can be incorporated into the control process for the fourth safety function performed by the control device 210.

Accordingly, in the present example, the management device 200 may activate an operation restriction function that restricts or prohibits the operation of the shovel 100 when an operator who remotely controls the shovel 100 or an observer who remotely monitors the shovel 100 operating with the automatic operation function has not performed a safety check around the shovel 100 for more than a predetermined time. That is, the management device 200 may activate the operation restriction when the operator or the observer has not checked images around the shovel displayed by the display device 230A for more than the predetermined time. This enables the operator who remotely operates the shovel 100 and the observer who remotely monitors the shovel 100 operating with the automatic operation function to be made aware that unless the safety check around the shovel 100 is performed, the operation of the shovel 100 will be restricted and work is unable to continue. The management device 200 may prompt the operator who remotely controls the shovel 100 or the observer who remotely monitors the shovel 100 operating with the automatic operation function to perform a safety check around the shovel 100 at intervals of the predetermined time or less. Accordingly, the management device 200 is able to prevent a situation in which an object around the shovel 100 contacts the shovel 100, thereby increasing the safety of the shovel 100 (itself).

<Other Examples of Control Processes for Safety Functions>

The first to third examples of the control process for the above-described safety functions (the third safety function and the fourth safety function) may be modified or altered as appropriate.

For example, in the first example (with reference to FIG. 5) described above, as in the case of the first safety function described above, after a certain period of time has elapsed since the start of operation of the notification function and the safety check function, the notification function and the safety check function may be temporarily stopped even when the safety check around the shovel 100 is not performed by the operator or the observer. Accordingly, for example, it is possible to prevent a situation in which the operator or the observer becomes accustomed to the continuous activations of the notification function and the safety check function, and the effects thereof are diminished.

For example, in the second example (with reference to FIG. 6) described above, as in the case of the second safety function described above, after a certain period of time shorter than the predetermined time has elapsed since the start of operation of the safety check function, the safety check function may be temporarily stopped even when the safety check around the shovel 100 is not performed by the operator or the observer. Accordingly, for example, it is possible to prevent a situation in which the operator or the observer becomes accustomed to the continuous activation of the safety check function and the effect thereof is diminished.

For example, in the first example described above, as in the case of the first safety function described above, the control device 210 may activate a safety check function to warn for (strongly prompt) an operator or an observer to perform a safety check around the shovel 100 when the operator or the observer fails to perform a safety check around the shovel 100 for a predetermined period of time or more after detection of a monitoring subject. In addition, the control device 210 may increase the strength level of prompting the operator or the observer to perform the safety check around the shovel 100 in three or more steps every time the predetermined period of time in which the operator has not performed the safety check around the shovel 100 has elapsed.

Further, for example, in the second example described above, as in the case of the second safety function described above, the control device 210 may activate a safety check function to warn for (strongly prompt) an operator or an observer to perform a safety check around the shovel 100 when the operator or the observer fails to perform a safety check around the shovel 100 for a predetermined period of time or more. The predetermined period of time may be set for a period longer than the predetermined time. This enables the control device 210 to strongly prompt the operator or the observer to perform a safety check around the shovel 100 in a situation where the operator or the observer does not perform a safety check around the shovel 100 even when a safety check function is activated. In addition, the control device 210 may increase the strength level of prompting the operator or the observer to perform the safety check around the shovel 100 in three or more steps every time the predetermined period of time in which the operator has not performed the safety check around the shovel 100 has elapsed.

For example, as in the above-described first safety function, in the first example (with reference to FIG. 5), the safety control part 304 may activate the operation restriction function in addition to the notification function and a safety check function. Thus, the control device 210 can prompt an operator or an observer of the management device 200 to perform a safety check around the shovel 100, as in the third example, when a monitoring subject is detected in a monitoring area around the shovel 100. Accordingly, the management device 200 prevents a situation in which an object in an area around the shovel 100 (itself) contacts the shovel 100 (itself), thereby increasing the safety of the shovel 100 (itself). In this case, the safety control part 304 may simultaneously activate the operation restriction function in addition to the notification function and the safety check function. Thus, the control device 210 can continue the operation restriction function until the operator or the observer of the management device 200 performs the safety check around the shovel 100. Thus, it is possible to substantially oblige the operator or the observer of the management device 200 to perform a safety check around the shovel 100 when a monitoring subject is detected around the shovel 100. Accordingly, the control device 210 can further prevents contact between an object around the shovel 100 and the shovel 100 the from occurring to further increase the safety of the shovel 100.

For example, when the operation restriction function is added to the first example described above, the control device 210 may activate the operation restriction function when a situation in which a safety check is not performed by an operator or an observer continues for a predetermined period of time or more after the detection of the monitoring subject. This enables the control device 210 to prompt the operator or the observer to perform a safety check around the shovel 100 while allowing the shovel to continue operating to some extent. Accordingly, the control device 210 can achieve both securing the safety of the shovel 100 or the work site in which the shovel 100 is located and preventing a deterioration in the work efficiency of the shovel 100.

For example, as in the above-described second safety function, in the above-described third example, the control device 210 may activate the operation restriction function when a situation in which an operator does not perform a safety check at intervals of a predetermined time or less continues for a predetermined period of time. The predetermined period of time may be set for a period longer than the predetermined time. This enables the control device 210 to prompt an operator or an observer to perform a safety check with respect to an area around the shovel 100 while allowing the shovel 100 to continue operating to some extent. Accordingly, the control device 210 can achieve both securing the safety of the shovel 100 or the work site in which the shovel 100 is located and preventing a deterioration in the work efficiency of the shovel 100.

### Modification/Alteration

While the embodiments have been described in detail above, the present disclosure is not limited to such particular embodiments, and various modifications and alterations are possible within the scope of the appended claims.

For example, although the above-described embodiments describe a safety check function that prompts an operator to perform a safety check with respect to an area around the shovel 100, a similar function may be employed for other work machines other than the shovel 100. Other work machines may include, for example, bulldozers, wheel loaders, mobile cranes, and the like.

According to the embodiments described above, the safety of the work machine can be improved.

It should be understood that the invention is not limited to the above-described embodiment, but may be modified into various forms on the basis of the spirit of the invention. Additionally, the modifications are included in the scope of the invention.

### DESCRIPTION OF THE REFERENCE NUMERALS

30 controller
40 imaging device
40B,40F,40L,40R camera
45 peripheral object information acquisition device
45BL,45BR,45L,45R sensor
50 display device
52 sound output device
54 input device (acquisition device)
56 line-of-sight detection device (acquisition device)
100 shovel (work machine)
200 management device (information processing device)
210 control device
220 communication device
230 output device
230A display device
240 input device
240A operation device
301 remote control part
302 object detection part
303 safety check detection part
304 safety control part
2101 remote control support part
2102 safety check detection part
2103 safety control part
T1 communication device

What is claimed is:

1. A work machine comprising:
one or more processors; and
a memory device storing a program, wherein when executed by the one or more processors, causes a computer of the work machine to perform a process including
prompting an operator to perform a safety check around the work machine at intervals of a predetermined time when the operator has not performed the safety check around the work machine for more than the predetermined time.

2. The work machine according to claim 1, wherein the process further comprises:
acquiring information about a presence or an absence of the safety check around the work machine performed by the operator.

3. The work machine according to claim 2, wherein the process further comprises:
detecting an operator's line of sight, wherein
the safety check around the work machine performed by the operator includes a state in which the operator's line of sight is viewing at least one of a side or a rear side of the work machine for a certain period of time or more.

4. The work machine according to claim 2, wherein the process further comprises:
receiving a predetermined input indicating that the operator has performed the safety check around the work machine.

5. The work machine according to claim 1, comprising:
an imaging device configured to image views around the work machine; and
a display device configured to display image information representing at least one view of a side or a rear side of the work machine based on an output of the imaging device, wherein
the safety check around the work machine performed by the operator includes checking of the image information displayed on the display device.

6. The work machine according to claim 1, wherein the process further comprises:
performing notification of a warning to the operator and at least one of a restriction or a prohibition of an operation of the work machine when a predetermined condition relating to a lack of the safety check around the work machine by the operator is met, the lack of the safety check around the work machine by the operator representing that the operator has not performed the safety check around the work machine for more than the predetermined time.

7. The work machine according to claim 6, wherein after the notification of the warning to the operator and starting of execution of the at least one of the restriction or the prohibition of the operation of the work machine, the execution is continued until the operator performs the safety check around the work machine.

8. The work machine according to claim 1, wherein the predetermined time varies with work contents or operation conditions.

9. The work machine according to claim 1, wherein the process further comprises:
acquiring information relating to a surrounding condition of the work machine;
detecting a predetermined object around the work machine based on the acquired information;
prompting the operator to perform the safety check around the work machine when the predetermined object is detected; and
prompting the operator to perform the safety check around the work machine at the intervals of the predetermined time when the predetermined object is not detected.

10. The work machine according to claim 1, wherein the process further comprises:
prompting the operator to perform the safety check around the work machine when the work machine is in a predetermined condition that is relatively suitable for the operator to perform the safety check around the work machine.

11. The work machine according to claim 6, wherein the process further comprises:
determining that the operator has performed the safety check around the work machine when the operator has performed the safety check around the work machine in a predetermined condition that is relatively suitable for the operator to perform the safety check around the work machine.

12. An information processing device comprising:
a communication device configured to receive from a work machine image information from an imaging device that images views around the work machine, or image information of at least one of a side or a rear side of the work machine generated based on an output of the imaging device;
a display device configured to display the image information representing at least one view of the side or the rear side of the work machine based on the image information received by the communication device; and
an operation device configured to receive a remote-control operation relating to the work machine, wherein
the communication device transmits a signal relating to an operation condition of the operation device operated by an operator to the work machine, and wherein
the operator who performs the remote-control operation is prompted to check the image information displayed on the display device at intervals of a predetermined time.

13. An information processing device comprising:
a communication device configured to receive from a work machine image information from an imaging device that images views around the work machine, or image information of at least one of a side or a rear side of the work machine generated based on an output of the imaging device; and
a display device configured to display the image information representing at least one view of the side or the rear side of the work machine based on the image information received by the communication device, wherein
an observer who monitors the work machine operating with automatic operation is prompted to check the image information displayed on the display device at intervals of a predetermined time.
